(19) United States
(12) Patent Application Publication
(10) Pub. No.: US 2020/0085045 A1
(43) Pub. Date: Mar. 19, 2020

(54) ANTIMICROBIAL POLYMERS AND ANTIMICROBIAL HYDROGELS

(71) Applicants: NANYANG TECHNOLOGICAL UNIVERSITY, Singapore (SG); CLEARLAB SG PTE LTD, Singapore (SG)

(72) Inventors: Bee Eng Mary CHAN, Singapore (SG); Chun Kiat YEO, Singapore (SG); Nguan Soon TAN, Singapore (SG); Peng LI, Singapore (SG); Zanru GUO, Singapore (SG); Mya Mya KHIN, Singapore (SG)

(21) Appl. No.: 16/494,415

(22) PCT Filed: Mar. 16, 2018
(86) PCT No.: PCT/SG2018/050117

§ 371 Date: Sep. 16, 2019

(30) Foreign Application Priority Data
Mar. 16, 2017 (SG) 10201702149V

(51) Int. Cl. A01N 37/44; C08F 283/04; C09D 151/08; C09D 5/14

(52) U.S. Cl. CPC A01N 37/44; C09D 5/14; C09D 151/08; C08F 283/04

(57) ABSTRACT

An antimicrobial polymer or hydrogel is provided. The antimicrobial polymer or hydrogel comprises a branched polyethylenimine (PEI) grafted with poly(ethylene glycol) methacrylate (PEGMA) of formula (I) or a branched polyethylenimine (PEI) grafted with poly(ethylene glycol) methacrylate (PEGMA) and decane of formula (II),

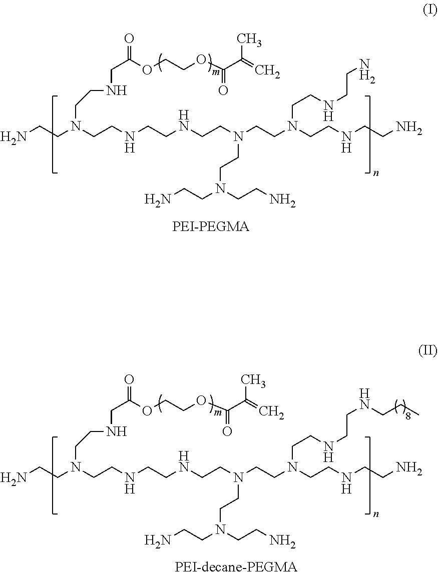

wherein:
m is an integer ranging from 1 to 20;
n is an integer ranging from 1 to 20;
in formula (I), the grafting ratio of PEI-PEGMA ranges from 1:1 to 1:20; and in formula (II), the grafting ratio of PEI-decane-PEGMA ranges from 1:1:1 to 1:20:20.

### CROSS-REFERENCE TO RELATED APPLICATION

This application claims the benefit of priority of Singapore Patent Application No. 10201702149V, filed Mar. 16, 2017, the contents of which being hereby incorporated by reference in its entirety for all purposes.

### TECHNICAL FIELD

Various embodiments relate generally to antimicrobial polymers and antimicrobial hydrogels, and in particular, to polymers and hydrogels comprised of branched polyethylenimine, and more specifically, to polymers and hydrogels comprised of polyethylenimine-graft-polyethylene glycol methacrylate (PEI-PEGMA) or polyethylenimine-graft-decane-graft-polyethylene glycol methacrylate (PEI-decane-PEGMA).

### BACKGROUND

Hydrogels might be a suitable material to create an antimicrobial coating, as their properties could be tuned to suit the intended application. Antimicrobial hydrogels that kill bacteria upon contact may be synthesized from cationic polymers.

Recently, polycationic polymers-based surface antimicrobial coatings were developed. Significant advantages of surface antimicrobial coating over systemic antibiotics and antimicrobials is that antimicrobial coating based on polycationic polymers have (1) lack of bacterial resistance, (2) prolonged effectiveness due to immobilization and lack of diffusion, (3) lack of toxicity due to immobilization of active agents, and (4) effectiveness against both Gram-positive bacteria, Gram-negative bacteria and fungus organisms.

Polyethylenimine (PEI) is a weakly basic, aliphatic, non-toxic synthetic polymer. As its chemical bonds consist of C—C and C—N, PEI possesses a high degree of biostability. Owing to the presence of primary, secondary, and tertiary amino groups on PEI macromolecules, it can be transformed into a polycation, which is widely used in biomedical applications such as gene delivery, enzyme immobilization, biosensors, separation and purification of biomacromolecules, etc. As it is a polycationic polymer, PEI-based nanoparticles were also prepared for antimicrobials. However, there are no reports regarding the use of PEI as a hydrogel for antimicrobial coatings.

### SUMMARY

Present disclosure is based on cationic polymers (or more specifically, copolymers) and highly microporous polycationic hydrogels that disrupt the cell envelope of bacteria that comes in contact with the cationic polymers or polycationic hydrogels (i.e. involving contact-active mechanism of killing bacteria).

According to one aspect of present disclosure, there is provided an antimicrobial polymer or hydrogel comprising a branched polyethylenimine (PEI) grafted with poly(ethylene glycol) methacrylate (PEGMA) of formula (I) or a branched polyethylenimine (PEI) grafted with poly(ethylene glycol) methacrylate (PEGMA) and decane of formula (II),

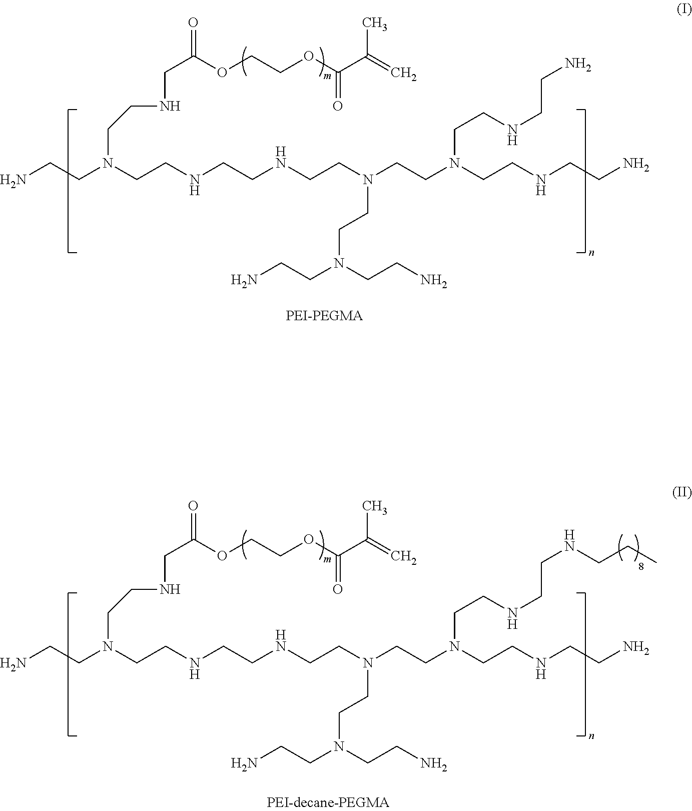

wherein:
m is an integer ranging from 1 to 20;
n is an integer ranging from 1 to 20;
in formula (I), the grafting ratio of PEI-PEGMA ranges from 1:1 to 1:20; and in formula (II), the grafting ratio of PEI-decane-PEGMA ranges from 1:1:1 to 1:20:20.

According to another aspect of present disclosure, there is provided a method for forming an antimicrobial polymer of formula (I), the method comprising:
dissolving polyethylenimine (PEI) in deionized water to form a PEI solution;
adding an alkali solution to the PEI solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (I).

According to yet another aspect of present disclosure, there is provided a method for forming an antimicrobial polymer of formula (II), the method comprising:
dissolving a decane-grafted polyethylenimine (PEI-decane) in deionized water to form a PEI-decane solution;
adding an alkali solution to the PEI-decane solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (II).

According to a further aspect of present disclosure, there is provided a method for forming an antimicrobial hydrogel of formula (I) or formula (II), the method comprising:
dissolving an antimicrobial polymer of formula (I) or formula (II), a crosslinker, and a UV initiator in deionized water to form a hydrogel solution; and
irradiating the hydrogel solution with UV light to form the antimicrobial hydrogel.

According to yet further aspect of present disclosure, there is provided a method for forming on a surface a coating of an antimicrobial hydrogel of formula (I) or formula (II), the method comprising:
dissolving an antimicrobial polymer of formula (I) or formula (II), a crosslinker, and optionally, a UV initiator, in deionized water to form a hydrogel solution;
subjecting the surface to a modification treatment;
depositing the hydrogel solution onto the modified surface; and
irradiating the hydrogel solution with UV light to form the coating of the antimicrobial hydrogel.

According to another aspect of present disclosure, there is provided a device having a surface coated with an antimicrobial hydrogel of formula (I) or formula (II).

According to yet another aspect of present disclosure, there is provided a method for killing microorganisms, the method comprising contacting an antimicrobial polymer or hydrogel of formula (I) or formula (II) with the microorganisms.

According to a further aspect of present disclosure, there is provided an antimicrobial polymer or hydrogel comprising a branched polyethylenimine (PEI) grafted with poly(ethylene glycol) methacrylate (PEGMA) and alkyl (R) of formula (III),

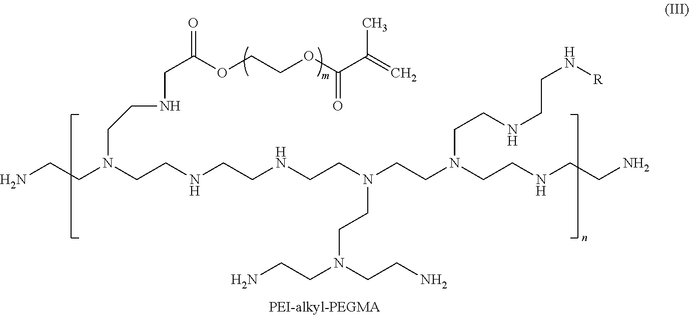

wherein:

m is an integer ranging from 1 to 20;

n is an integer ranging from 1 to 20;

R is a linear or branched, substituted or unsubstituted C₅-C₁₅ alkyl; and

the grafting ratio of PEI-alkyl-PEGMA ranges from 1:1:1 to 1:20:20.

According to another aspect of present disclosure, there is provided a method for forming an antimicrobial polymer of formula (III), the method comprising:
dissolving an alkyl-grafted polyethylenimine (PEI-alkyl) in deionized water to form a PEI-alkyl solution;
adding an alkali solution to the PEI-alkyl solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (III).

According to yet another aspect of present disclosure, there is provided a method for forming an antimicrobial hydrogel of formula (III), the method comprising:
dissolving an antimicrobial polymer of formula (III), a crosslinker, and a UV initiator in deionized water to form a hydrogel solution; and
irradiating the hydrogel solution with UV light to form the antimicrobial hydrogel.

According to another further aspect of present disclosure, there is provided a method for forming on a surface a coating of an antimicrobial hydrogel of formula (III), the method comprising:
dissolving an antimicrobial polymer of formula (III), a crosslinker, and optionally, a UV initiator, in deionized water to form a hydrogel solution;
subjecting the surface to a modification treatment;
depositing the hydrogel solution onto the modified surface; and
irradiating the hydrogel solution with UV light to form the coating of the antimicrobial hydrogel.

According to another aspect of present disclosure, there is provided a device having a surface coated with an antimicrobial hydrogel of formula (III).

According to yet another aspect of present disclosure, there is provided a method for killing microorganisms, the method comprising contacting an antimicrobial polymer or hydrogel of formula (III) with the microorganisms.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows ¹H NMR spectrum of PEI-decane in D₂O.

FIG. 2 shows ¹H NMR spectrum of PEI-decane grafted with PEGMA in D₂O.

FIG. 3 shows FESEM images of the freeze-dried surface morphology of contact lens: (a) pristine Clearlab A lens, (b) PEI-decane-PEGMA (1:10:1) coated lens, (c) PEI-decane-PEGMA (1:10:2) coated lens, (d) PEI-decane-PEGMA (1:10:4) coated lens, (e) PEI-decane-PEGMA (1:10:8) and (f) PEI-decane-PEGMA (1:10:16) coated lens.

FIG. 4 shows coating antimicrobial assay via agar plate visualization. Bacterial were incubated on the tested surface for 1 h (Control one is without coating surface), and were then transferred to Luria broth agar media and further incubated at 37° C. in the incubator for 18 h.

FIG. 5 shows the morphology of bacteria in contact with PEI-decane-PEGMA coated contact lens (right) and control (left, without coating).

FIG. 6 shows in vitro bio-compatibility of PEI-PEGMA and PEI-decane-PEGMA hydrogels on human dermal fibroblast cells. Transwell MTT (left) showed more than 95% of cell viability for both hydrogels, meaning that there were minimal leaching from the hydrogels. Contact MTT (right) showed more than 85% cell viability for both hydrogels, meaning that the hydrogels were quite compatible in contact with the cells.

FIG. 7 shows swelling kinetics of hydrogels. Both PEI-PEGMA and PEI-decane-PEGMA hydrogels swelled very rapidly, reaching more than 90% of their maximum swelling mass at the first time point (10 min). The hydrogels were able to absorb more than 11 times their dry mass of water. These swelling kinetics demonstrated that they are a very suitable material for use in wound dressings.

FIG. 8 shows in vivo bacteria CFU of MRSA when treated with control and PEI-PEGMA hydrogel. Approximately 10⁷ CFU of MRSA survived on the control after 3 days of treatment but none survived when treated with PEI-PEGMA hydrogel. This corresponds to a more than 7 log reduction of bacteria or more than 99.99999% killing of bacteria by the hydrogel as compared to the control.

FIG. 9 shows wound condition on Days 0, 3, 5, 7, 9 and 14 of the experiment. Approximately 6 mm diameter of wound was created on Day 0 and infected with MRSA. On all days, the wound of the PEI-PEGMA hydrogel treated mice were slightly smaller and cleaner than the wound of the control mice. Scale bar=5 mm. Arrows signify secondary wound sites.

FIG. 10 shows in vivo wound infection mice model. Bacterial counts of (A) MRSA USA300, (B) CR-AB, (C) CR-PA and (D) PAO1 on various treated and control wounds after one day in a 24 h post-infection treatment model (n=6). * denotes P<0.05 and ** denotes P<0.01. E) Table summarizing the log reduction data from FIG. A-D. F) Bacterial counts of MRSA USA300 on various treated and control wounds on days 1, 3, 5 and 7 (n=6).

FIG. 11 shows sol content of hydrogels for the PEI(25K)-PEGMA series (n=3). Beyond 8 min of UV time, PEI-PEGMA hydrogel has a plateaued sol content of ˜11-17% depending on the PEGMA grafting ratio. A higher PEGMA grafting decreased the sol content as higher crosslinking occurs.

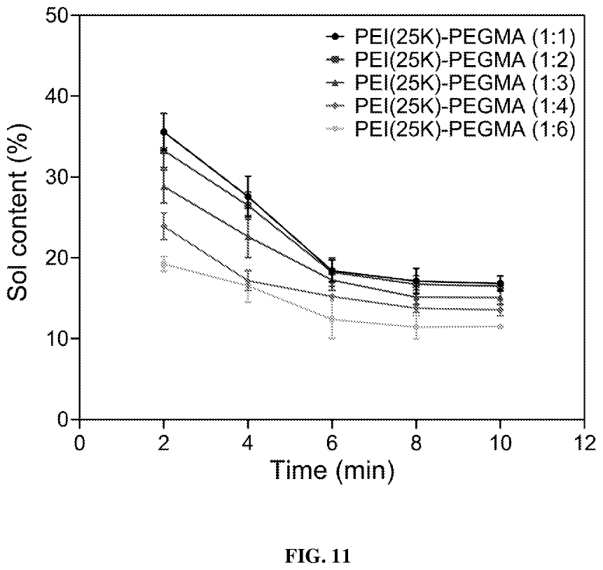

FIG. 12 shows imaging of bacteria on hydrogel. a) Morphology of cross-section of PEI(25K)-PEGMA (1:5) hydrogel using SEM. b-c) Morphology of (b) MRSA and (c) PAO1 on hydrogel using SEM. Black arrows represent bacterial debris. d-g) Confocal images of bacteria on PEI(25K)-PEGMA (1:5) hydrogel using LIVE/DEAD assay. (d) MRSA control, (e) MRSA on hydrogel, (f) PAO1 control and (g) PAO1 on hydrogel. Green colour (d, f) represents viable bacteria while red colour (e, g) represents dead bacteria.

FIG. 13 shows the morphology of cross-section of (A) control PEGDMA hydrogel, (B) MRSA USA300 and (C) PA01 on control hydrogel using FE-SEM. Morphology of cross-section of (D) PEI hydrogel, (E) MRSA USA300 and (F) PA01 on PEI hydrogel using FE-SEM. Morphology of cross-section of (G) PDP hydrogel, (H) MRSA USA300 and (I) PA01 on PDP hydrogel using FE-SEM. Insets show magnified morphology (scale bar=1 μm). Arrows represent bacteria debris.

FIG. 14 shows the characteristics of hydrogels. A) Cell viability of human dermal fibroblasts (HDF) when incubated with PEI and PDP hydrogels for 24 h with Transwell and contact MTT assays (n=3). B) Photos of 6 mm circular disc of PEI and PDP hydrogel with scale reference. C) Swelling ratio (final mass/initial mass) against time of PEI and PDP hydrogels (n=3). D) Confocal images of (i) MRSA USA300 and (ii) PA01 on PEI hydrogel surface using LIVE/DEAD assay. E) Confocal images of (i) MRSA USA300 and (ii) PA01 on control (PEGDMA) hydrogel surface using LIVE/DEAD assay. Incubation time for bacteria on hydrogel is 1 h. Green colour indicates viable bacteria while red colour indicates dead bacteria.

FIG. 15 shows contact angle of water on PEI and PDP hydrogels during 0 and 2 min.

FIG. 16 shows full wound healing study for the in vivo prophylactic model. A) Table summarizing the log reduction data for 0⁺ h post-infection treatment model. B) Wound sizes of infection control and PEI hydrogel treated wounds on various days as a percentage of the initial wound size (n=6). C) Wound pictures of infection control and PEI hydrogel treated wounds on various days. Scale bar=5 mm. Black arrows indicate secondary infection sites. D) H&E stains of the tissues beside the wound bed showing the extent of inflammation in wounds of infection control and PEI hydrogel treated wounds on day 3. Black arrows signify inflamed areas as indicated by dark spots. Scale bar=300 μm. E) Percentage of CD11b⁺ cells on wounds after treatment for 3 days with MRSA USA300 and PA01 infected mice (n=6). The percentage of CD11b⁺ cells is directly proportional to the extent of inflammation in the skin. * denotes P<0.05 and ** denotes P<0.01.

FIG. 17 shows LIVE/DEAD assay performed on bacteria controls and bacteria treated on hydrogels. Green (i.e. control) signifies live bacteria while red (i.e. hydrogel) signifies dead bacteria.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and chemical changes may be made without departing from the scope of the invention. The various embodiments are not necessarily mutually exclusive, as some embodiments can be combined with one or more other embodiments to form new embodiments.

Hydrogels are networks of polymer chains that are highly hydrophilic, which are highly absorbent and contain a high water content. Hydrogels may be constructed from single or multiple monomers covalently or non-covalently cross-linked in order to control their swelling capacities and structure. Their swelling ability, structure, strength and water content can be affected by pH, temperature, or ionic strength.

Present disclosure relates to polycationic hydrogels formed of cationic polymers, which are shown to exhibit antimicrobial activity. The polycationic hydrogels or cationic polymers may be immobilized or otherwise coated on surfaces to impart the antimicrobial ability. The antimicrobial action of immobilized polycationic hydrogels or cationic polymers may be due to their ability to interact strongly with negatively charged phospholipids, allowing electrostatic interactions to govern initial binding to target cell membranes, and then the hydrophobic moieties on polymers interact with the inner hydrophobic core of the bacterial membrane resulting in a disruption in integrity and subsequent cell death. Thus, surface charge density and hydrophobicity are the main factors that affect antimicrobial activity of surface coatings. Since the pKa value of the imino group is approximately 10 to 11, polyethylenimine (PEI) is a positively charged molecule in the physiological environment solutions (pH about 7.2).

In particular, branched PEI containing primary, secondary, and tertiary amino groups on the backbone of the PEI macromolecule is discussed herein.

Thus, in accordance with one aspect of present disclosure, there is provided an antimicrobial polymer or hydrogel comprising a branched polyethylenimine (PEI) grafted with poly(ethylene glycol) methacrylate (PEGMA) of formula (I) or a branched polyethylenimine (PEI) grafted with poly(ethylene glycol) methacrylate (PEGMA) and decane of formula (II),

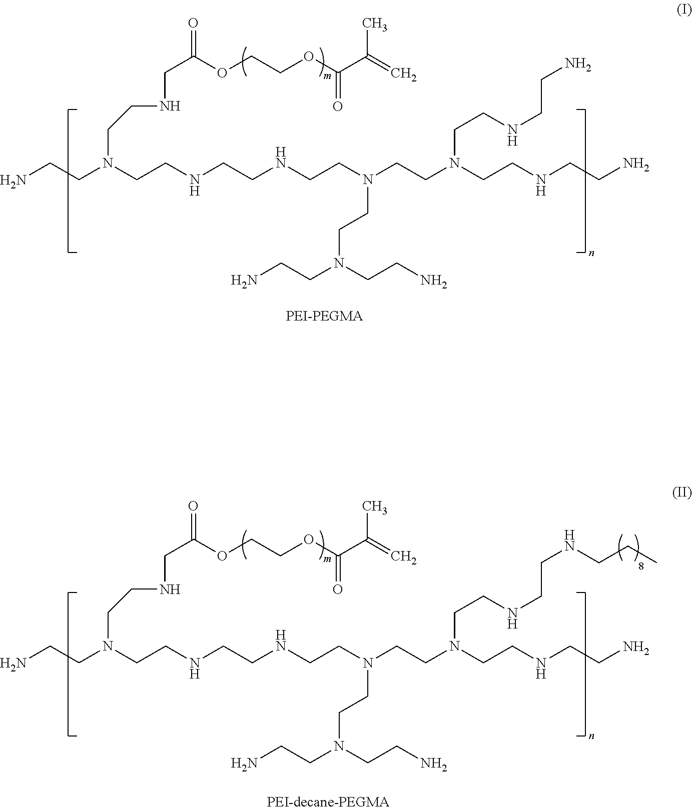

wherein:

m is an integer ranging from 1 to 20;

n is an integer ranging from 1 to 20;

in formula (I), the grafting ratio of PEI-PEGMA ranges from 1:1 to 1:20; and

in formula (II), the grafting ratio of PEI-decane-PEGMA ranges from 1:1:1 to 1:20:20.

A person skilled in the art would readily recognize that in formula (I), the branched PEI contains one tertiary amino group in the main chain or backbone that is grafted with a polyethylene glycol methacrylate-containing moiety (herein denoted PEI-PEGMA). The cationic PEI was grafted with PEGMA to allow the PEI-PEGMA to become UV-polymerizable. PEGMA not only bestows the post-modification properties on PEI but also may improve the biocompatibility with mammalian cells.

In formula (I), the grafting ratio denotes the number of PEGMA moieties (or density) grafted onto the PEI. The number of PEGMA moieties may range from 1 to 20.

In other words, the grafting ratio of PEI-PEGMA ranges from 1:1 to 1:20. In various embodiments, the number of PEGMA moieties grafted onto one PEI may be 5, 10, or even 20. In preferred embodiments, the number of PEGMA moieties grafted onto one PEI is 5.

The antimicrobial polymer or hydrogel of formula (II) is an extension or variation of formula (I), wherein in addition to the grafted PEGMA moiety as described above for formula (I), there is yet another moiety grafted onto the PEI. This other moiety in formula (II) may be an alkyl group and specifically, decane is grafted onto the PEI.

As mentioned above, the hydrophobicity of the cationic polymer or polycationic hydrogel is one main factor that affects antimicrobial activity of surface coatings. Therefore, an alkyl group such as decane is purposefully grafted onto hydrophilic PEI to impart hydrophobicity to improve the antimicrobial activity. It is to be understood and appreciated by a person skilled in the art that the scope of the present disclosure is not limited to the alkyl group being decane. For example, a C₅-C₁₅ alkyl group, linear or branched, substituted or unsubstituted, may be grafted onto hydrophilic PEI so long as the C₅-C₁₅ alkyl group imparts hydrophobicity to improve the antimicrobial activity. C₄ and below alkyl groups have too low boiling points to take part in the chemical reaction to form the PEI-alkyl. Since the reaction may be carried out at about 80° C., these alkyl groups might just be refluxed instead of participating in the reaction. Also, they are not too hydrophobic and may not have any noticeable increase in the antibacterial property. On the other hand, C₁₆ and above alkyl groups are too hydrophobic and might drastically decrease the solubility of the polymer in water, hence the hydrogel solution might not be formed.

In formula (II), the grafting ratio denotes the number of decane moieties (or density) grafted onto the PEI. The number of decane moieties may range from 1 to 20. In other words, the grafting ratio of PEI-decane ranges from 1:1 to 1:20. In preferred embodiments, the number of decane moieties grafted on one PEI is 10.

In formula (II), the grafting ratio further denotes the number of PEGMA moieties (or density) grafted onto the PEI. The number of PEGMA moieties may range from 1 to 20. In other words, the grafting ratio of PEI-PEGMA ranges from 1:1 to 1:20. In various embodiments, the number of PEGMA moieties grafted onto one PEI may be 1, 2, 4, 8, or even 16. In preferred embodiments, the number of PEGMA moieties grafted onto one PEI is 16.

In various embodiments, the antimicrobial polymer or hydrogel may be PEI-PEGMA (1:5), PEI-PEGMA (1:10), or PEI-PEGMA (1:20), where the numerals in brackets refer to the ratio of PEI-PEGMA.

In various embodiments, the antimicrobial polymer or hydrogel may be PEI-decane-PEGMA (1:10:1), PEI-decane-PEGMA (1:10:2), PEI-decane-PEGMA (1:10:4), PEI-decane-PEGMA (1:10:8), or PEI-decane-PEGMA (1:10:16), where the numerals in brackets refer to the ratio of PEI-decane-PEGMA.

In various embodiments, PEI has an average molecular weight of between 800 and 750 K Da. For example, PEI may have an average molecular weight of 800, 25 K, or 750 K Da. In preferred embodiments, PEI may have an average molecular weight of 25 K Da.

According to another aspect of present disclosure, there is provided a method for forming an antimicrobial polymer of formula (I), the method comprising:
dissolving polyethylenimine (PEI) in deionized water to form a PEI solution;
adding an alkali solution to the PEI solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (I).

According to yet another aspect of present disclosure, there is provided a method for forming an antimicrobial polymer of formula (II), the method comprising:
dissolving a decane-grafted polyethylenimine (PEI-decane) in deionized water to form a PEI-decane solution;
adding an alkali solution to the PEI-decane solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (II).

According to a further aspect of present disclosure, there is provided a method for forming an antimicrobial hydrogel of formula (I) or formula (II), the method comprising:
dissolving an antimicrobial polymer of formula (I) or formula (II), a crosslinker, and a UV initiator in deionized water to form a hydrogel solution; and
irradiating the hydrogel solution with UV light to form the antimicrobial hydrogel.

According to yet further aspect of present disclosure, there is provided a method for forming on a surface a coating of an antimicrobial hydrogel of formula (I) or formula (II), the method comprising:
dissolving an antimicrobial polymer of formula (I) or formula (II), a crosslinker, and optionally, a UV initiator, in deionized water to form a hydrogel solution;
subjecting the surface to a modification treatment;
depositing the hydrogel solution onto the modified surface; and
irradiating the hydrogel solution with UV light to form the coating of the antimicrobial hydrogel.

In various embodiments, the modification treatment may include a plasma treatment, an ozone treatment, an iron (II) oxide treatment, or any other treatments that generate free radicals on the surfaces. In certain embodiments, the use of a UV initiator in the above method for forming on a surface a coating of an antimicrobial hydrogel of formula (I) or formula (II) may not be needed since the free radicals generated during the modification treatment aid in the subsequent polymerization process to form the coating of the antimicrobial hydrogel.

According to another aspect of present disclosure, there is provided a device having a surface coated with an antimicrobial hydrogel of formula (I) or formula (II).

According to yet another aspect of present disclosure, there is provided a method for killing microorganisms, the method comprising contacting an antimicrobial polymer or hydrogel of formula (I) or formula (II) with the microorganisms.

According to a further aspect of present disclosure, there is provided an antimicrobial polymer or hydrogel comprising a branched polyethylenimine (PEI) grafted with poly(ethylene glycol) methacrylate (PEGMA) and alkyl (R) of formula (III),

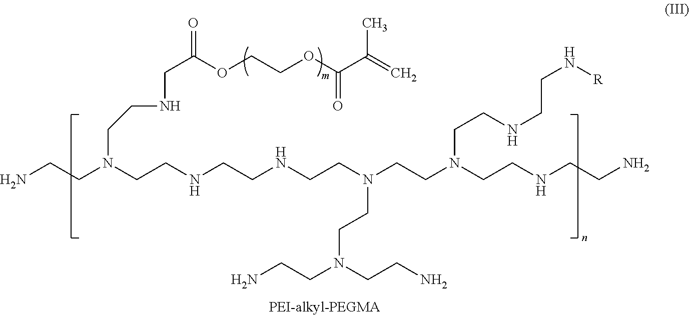

wherein:

m is an integer ranging from 1 to 20;

n is an integer ranging from 1 to 20;

R is a linear or branched, substituted or unsubstituted C₅-C₁₅ alkyl; and

the grafting ratio of PEI-alkyl-PEGMA ranges from 1:1:1 to 1:20:20.

According to another aspect of present disclosure, there is provided a method for forming an antimicrobial polymer of formula (III), the method comprising:
dissolving an alkyl-grafted polyethylenimine (PEI-alkyl) in deionized water to form a PEI-alkyl solution;
adding an alkali solution to the PEI-alkyl solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (III).

According to yet another aspect of present disclosure, there is provided a method for forming an antimicrobial hydrogel of formula (III), the method comprising:
dissolving an antimicrobial polymer of formula (III), a crosslinker, and a UV initiator in deionized water to form a hydrogel solution; and
irradiating the hydrogel solution with UV light to form the antimicrobial hydrogel.

According to another further aspect of present disclosure, there is provided a method for forming on a surface a coating of an antimicrobial hydrogel of formula (III), the method comprising:
dissolving an antimicrobial polymer of formula (III), a crosslinker, and optionally, a UV initiator, in deionized water to form a hydrogel solution;
subjecting the surface to a modification treatment;
depositing the hydrogel solution onto the modified surface; and
irradiating the hydrogel solution with UV light to form the coating of the antimicrobial hydrogel.

In various embodiments, the modification treatment may include a plasma treatment, an ozone treatment, an iron (II) oxide treatment, or any other treatments that generate free radicals on the surfaces.

According to another aspect of present disclosure, there is provided a device having a surface coated with an antimicrobial hydrogel of formula (III).

According to yet another aspect of present disclosure, there is provided a method for killing microorganisms, the method comprising contacting an antimicrobial polymer or hydrogel of formula (III) with the microorganisms.

For the sake of clarity and brevity, it is to be understood that the above discussion with respect to the antimicrobial polymer or hydrogel of formula (I) or formula (II) applies to the antimicrobial polymer or hydrogel of formula (III), where appropriate, and is not repeated herein.

In order that the invention may be readily understood and put into practical effect, particular embodiments will now be described by way of the following non-limiting examples.

### EXAMPLES

### Example 1

In this example, a durable antimicrobial hydrogel coating for contact lens is developed by a combination of plasma treatment and UV photo-polymerization of alkylated polyethyleneimine-graft-polyethylene glycol methacrylate (PEI-decane-PEGMA). The thus-developed PEI-decane-PEGMA hydrogel coating shows excellent broad spectrum antimicrobial activity towards both Gram-negative and Gram-positive bacteria and fungus. The % kill and log reduction of the coating are higher than 99.99% and 4.0, respectively.

Materials and Methods

Materials

Branched polyethyleneimine (PEI, Sigma-Aldrich, Mₙ=10⁴, M_{w}/Mₙ=2.5) was lyophilized to dryness before use. Chloro-functionalized poly(ethylene glycol) methacrylate (Cl-PEGMA) was synthesized briefly described as follows. 11.8 mL (35.3 mmol) of PEGMA was first dissolved in 100 mL of toluene, 11.25 mL (141.2 mmol) of chloroacetyl chloride was added into the solution and then stirred and refluxed for 24 h at 120° C. After the reaction, the solution was subjected to solvent evaporation and the concentrate was subsequently added with methylene chloride (100 mL) for dissolution. Potassium carbonate was then added and the mixture was stirred for 10 min. After filtration and solvent evaporation of the filtrate, the product was obtained.

1-Bromodecane, sodium hydroxide (NaOH), and isopropanol were purchased from Sigma-Aldrich Corp. and used as received. Absolute ethanol was purchased from VWR Pte Ltd (Singapore) and used without further purification.

Characterizations

¹H NMR spectra were recorded at 25° C. on a Bruker AV300 NMR spectrometer at 300 MHz. Chemical shifts (6) were reported in parts per million (ppm) with reference to the internal standard protons of tetramethylsilane (TMS). Field emission scanning electron microscopy (FE-SEM) observation was held on a JSM-6701F (JEOL, Japan).

Preparation of Alkylated Polyethyleneimine

Polyethyleneimine (PEI) with different alkyl groups were prepared through an alkylation reaction by varying the 1-Bromodecane/PEI feed ratio (Scheme 1, Table 1).

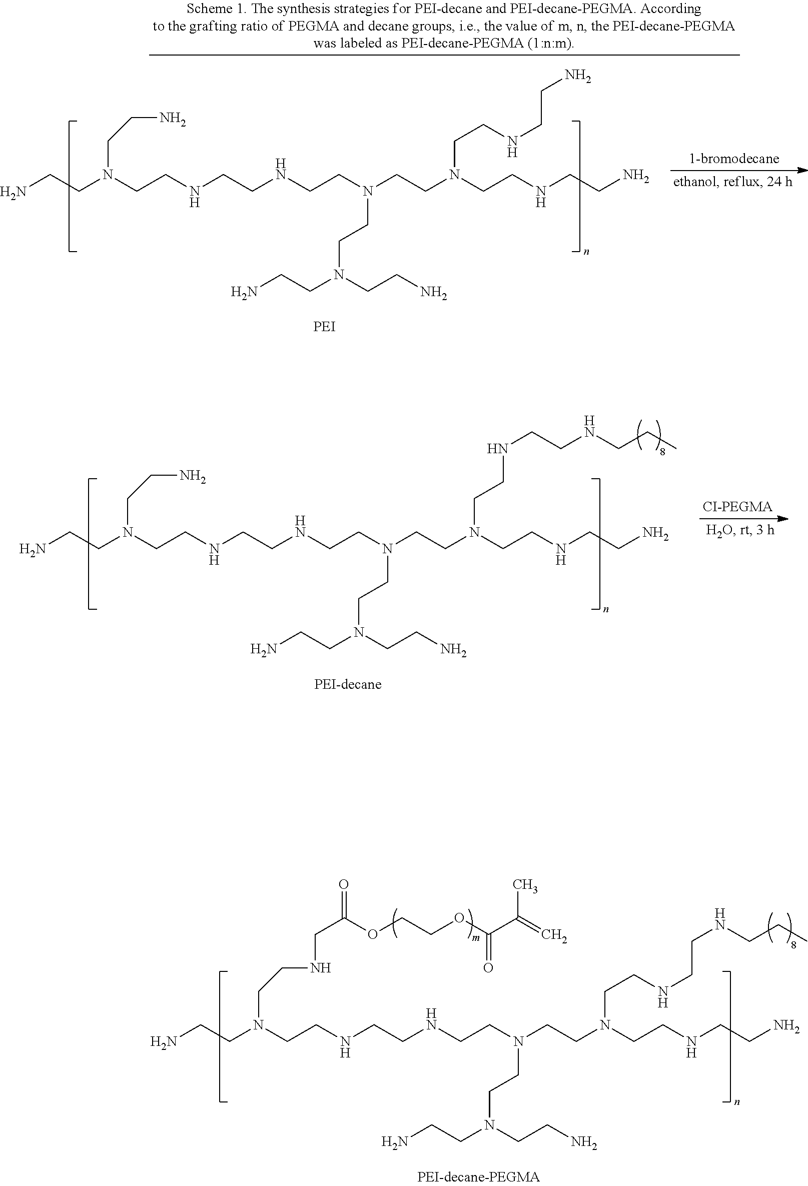

TABLE 1
MIC of qPEI with different molecular weight

| | | | Gram- | |
|---|---|---|---|---|
| | Gram-negative | | positive | Fungus |
| MIC (μg/ml) | E. coli | P. aeruginosa | S. aureus | C. albicans |
| PEI | 312 | 312 | 156 | 625 |
| PEI-decane (1:5) | 78 | 156 | 156 | 1250 |
| PEI-decane (1:10) | 39 | 39 | 19.5 | 1250 |
| PEI-decane (1:15) | 78 | 78 | 78 | 1250 |
| PEI-decane (1:20) | 39 | 78 | 78 | 1250 |

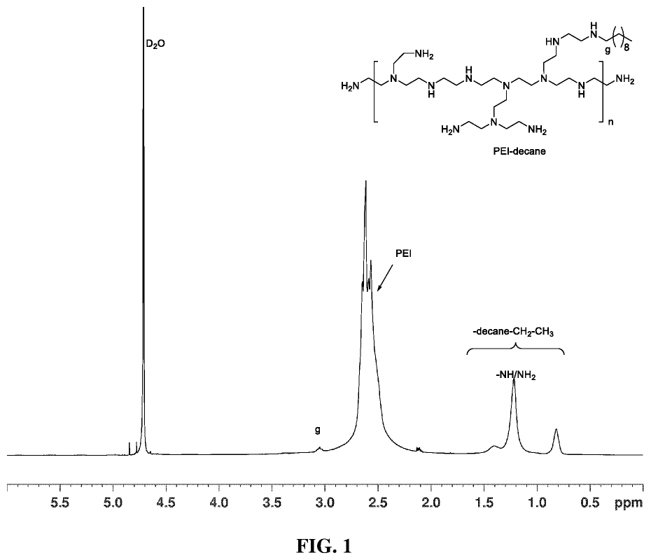

The number of the polymer name means the feed ratio of 1-Bromodecane to PEI. A typical procedure for preparation of PEI-decane (1:10) was as follows: PEI (2.0 g, 0.2 mmol) was dissolved in 50 mL of absolute ethanol and was alkylated with 0.442 g of 1-Bromooctane (2 mmol) under reflux conditions for 24 h. The generated HBr was neutralized with 0.2 g of sodium hydroxide under the same conditions for an additional 24 h. After removing the solvent, the resulting residue was dissolved in water and dialyzed against distilled water for 4 days. The obtained product was freeze dried for 24 h to give the polymer PEI-decane (1:10). The other polymers with various grafting ratios were prepared by the similar procedure, and the detailed characterization results were given in FIG. 1. ¹H NMR for PEI-decane (10:1) (300 MHz, D₂O): δ=0.75-0.96 ppm (CH₃ in decane group), δ=0.96-1.6 ppm (CH₂ in decane group), δ=2.1-3.18 ppm (CH₂ in PEI).

Preparation of PEI-Decane Grafted with PEGMA (PEI-Decane-PEGMA)

The PEI-decane grafted with various ratios of PEGMA was performed as briefly described as follows. For simplicity, PEI-decane-PEGMA (1:10:4) is described as an example. 1 g of PEI-decane (1:10) was first dissolved in 10 mL deionized water, and 0.4 mL of NaOH solution (1 M) was then added. Then CL-PEGMA (0.16 g) in isopropanol (1 mL) was added to the solution in a dropwise manner. The mixture was reacted for 3 h with stirring at room temperature and then subjected to dialysis (molecular weight cut-off (MWCO) 10344). The final product was gained via lyophilization.

Minimum Inhibitory Concentration (MIC)

The MIC (minimum inhibitory concentration) was evaluated for antimicrobial susceptibility of antimicrobial polymers. Bacteria species such as E. coli (K12), S. aureus (newman), P. aeruginosa (PAO1), and C. albicans (ATCC10231) were used in the MIC test. Bacteria were inoculated and developed in 5 mL of Mueller-Hinton broth (MHB, Fluka, Analytical grade for MIC test) at 37° C. under continuous shaking at 200 rpm to mid log phase. Then, mid log phase bacteria medium was used for the preparation of the dilute bacteria suspension to conduct the antimicrobial susceptibility test. A starting concentration of antimicrobial polymer used was 1000 μg/mL. Then, 12 serial two-fold dilutions of antimicrobial polymer solutions were made in 100 μL of MHB for each well of a sterile 96-well flat-bottomed microliter plate. Dilutions of antimicrobial agents in MHB provided the range between 1000 and 8 μg/mL. After that, each well was inoculated with 100 μL of dilute bacteria suspension which had optical density 0.0002 and the final inoculum of each well provided 5×10⁵ CFU/mL (where CFU denotes colony-forming units). The microliter plate was incubated in the incubator at 37° C. for 18 h. Microbial growth in each well was determined by measuring optical density (OD) of the suspension in each well with Biorad microplate spectrophotometer (Benchmarkplus) at 600 nm. Replicate measurements were conducted for each bacteria and concentration of antimicrobial agent. Positive control samples without antimicrobial agents and negative control samples without bacteria suspensions were applied in this experiment. MIC is evaluated as the lowest concentration of antimicrobial agent required to inhibit growth of the bacteria after 18 h of incubation.

Surface Coating of PEI-Decane-PEGMA on Contact Lens

Contact lens A was provided by Clearlab company. The contact lens were first activated with argon plasma (March PX-500™, the conditions were 100 W, 400 mTorr and 120 s) and then exposed to air for 15 min to generate surface peroxide groups. The pretreated contact lenses were then immersed in 0.49 mL solution containing PEI-decane-PEGMA (10 wt %) and PEGDMA (5%), then irradiated by UV light (at wavelength 365 nm and intensity of 10 mW cm⁻²) for 15 min. After UV irradiation, the samples were taken out and washed with deionized water to remove un-grafted reactants and adsorbed homopolymers.

Antimicrobial Assay of qPEI-PEGMA Surface Coatings

(1) Preparation of Bacteria Medium

Bacteria strains were inoculated and developed in 5 mL of MHB media at 37° C. with continuous shaking at 200 rpm to mid log phase. 1 mL of bacteria suspension was added into a sterile tube and MHB medium was removed by centrifugation. Bacteria were washed with 1 mL of phosphate buffered saline (PBS—consists of 137 mM NaCl, 2.7 mM KCl and 10 mM phosphate buffer, pH 7.2) twice and bacteria suspension was prepared with 1 mL of PBS.

(2) Inoculation of Bacteria on Coated Contact Lens

Contact lens was coated with the antimicrobial polymer. After coating, coated contact lens was washed with deionized water for five times. 10 μL of bacteria suspension in PBS (5×10⁸ CFU/mL) was distributed onto the surface of coated contact lens which was placed inside the tissue culture plate. Bacteria suspension without samples in the plate was used as a control. The plates were incubated at 37° C. for 1 h with 90% relative humidity.

(3) Plate Counting of Bacteria

2 mL of PBS was added to each tissue culture plate after incubation. 900 μL of PBS was inserted in each well of 24-well plate. Then, a series of 10-fold dilution of bacteria suspension was prepared and plating was prepared in Luria broth (LB) agar media (LB broth with agar, Sigma). The plates were incubated at 37° C. in the incubator for 18 h and CFU were counted.

Results are evaluated as follows:

$$Log reduction = Log ( cell count of control ) - Log ( survivor count on coated lens )$$

$$\% kill = \frac{C ell count of control - Survivor count on coated lens}{C ell count of control} \times 100$$

Microorganism Morphology Study

10 μL inoculum (5×10⁸ CFU mL⁻¹) of each pathogen was spread onto the contact lens surfaces and incubated for 1 h at 37° C. and a relative humidity of not less than 90%, followed by immediately fixed with glutaraldehyde (4.0%, 3 mL) solution for 4 h. The films were dehydrated by adding aqueous ethanol in a graded series (20%-100%) and then dried by a nitrogen flow. The microbes on the contact lens were observed by FE-SEM.

Results and Discussion

Synthesis

The antimicrobial action of immobilized cationic polymers may be due to their ability to interact strongly with negatively charged phospholipids, allowing electrostatic interactions to govern initial binding to target cell membranes, and then the hydrophobic moieties on polymers interact with the inner hydrophobic core of the bacterial membrane resulting in a disruption in integrity and subsequent cell death. Thus, surface charge density and hydrophobicity are the main factors that affect antimicrobial activity of surface coatings. Since the pKa value of the imino group is approximately 10 to 11, PEI is a positively charged molecule in the physiological environment solutions (pH about 7.2).

To further improve its antimicrobial properties, hydrophobicity groups such as alkyl moieties are introduced into polymer backbone. Resorting to the alkylation reaction between 1-bromodecane and the amino groups on the PEI backbone, PEI grafted with various decane groups were prepared by changing the ratio of bromodecane/PEI. ¹H NMR was used to characterize PEI-decane. As shown in FIG. 1, the proton signals of PEI and decane groups are found in ¹H NMR spectrum. Based on the integral area of the protons of decane (about 0.7 to 0.9 ppm), in addition, it was found that the degree of grafted decane groups increases according to an increase in the feeding ratio, indicating that a series of PEI-decane with various decane groups were obtained.

To form stable coating on the surface of contact lens, PEI-decane needs to be grafted onto the contact lens covalently. A combination of plasma treatment and photo-polymerization at the contact lens surface is shown to be a suitable strategy for forming a stable coating on the contact lens. In order for photo-polymerization to take place, double bond groups need to be introduced in PEI-decane. Taking into account the biocompatible properties, PEGMA were introduced in PEI-decane by alkylation reaction between Cl-PEGMA and the amino groups of PEI-decane, forming PEI-decane-PEGMA.

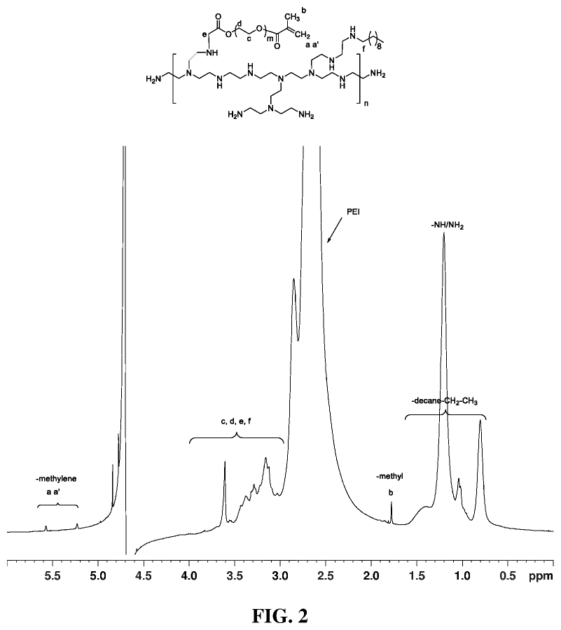

To explore the effects of PEGMA contents upon the coating formation, PEI-decane-PEGMA with differing densities of PEGMA functions were prepared. ¹H NMR was used to characterize PEI-decane-PEGMA. As shown in FIG. 2, the signals of PEI-decane and PEGMA were observed, especially for the double bond protons at 5.58 ppm and 6.14 ppm, indicating that PEI-decane-PEGMA was prepared. Besides, the degree of grafted PEGMA increases as its feeding ratio increases.

Coating Formation on Contact Lens

To form a coating, the contact lens was first subjected to argon plasma treatment to generate peroxide groups on the surface of the contact lens. These peroxide groups were used as surface initiators in the UV initiated surface grafting polymerization (Scheme 2).

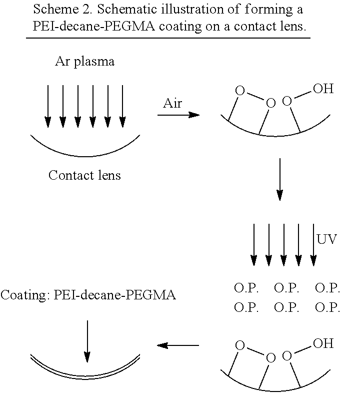

PEI-decane-PEGMA was used to make the surface coating on the Clearlab contact lens (A lens). In order to confirm the coating formation, FESEM observation was carried out (not shown) since it is a typical technique for characterizing surface morphology. The uncoated contact lens exhibits a smooth surface. However, the contact lens coated with PEI-decane-PEGMA show winkle surfaces, indicating that a thin layer of PEI-decane-PEGMA was immobilized on the surfaces of the contact lens.

Meanwhile, the coating formed by polymers with different PEGMA density was studied. It is found that the winkle coating becomes more and more homogenous with an increase in the content of PEGMA in PEI-decane-PEGMA. When the grafting degree of PEGMA is 4, i.e. PEI-decane-PEGMA (1:10:4), a homogenous coating is observed. If the grafting degree of PEGMA was further increased, the coating becomes compact, attributing to the higher crosslink degree.

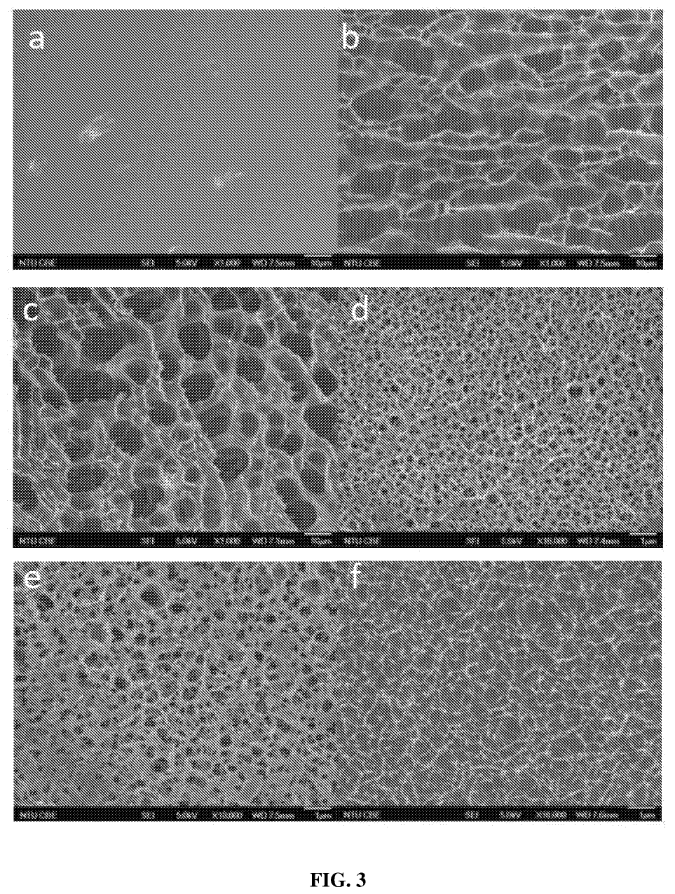

To further observe the morphology of coating in water, the coated lenses were fixed by liquid nitrogen, and then freeze dried. Similar to the uncoated contact lens dried in oven, the uncoated contact lens also shows a smooth surface (FIG. 3(a)). For the contact lens coated by PEI-decane-PEGMA (1:10:1), the surface exhibits a bush structure (FIG. 3(b)), as the polymer was designed and synthesized to have only one PEGMA group per chain so that it formed a brush from the surface. With the increase in PEGMA content, the network structures which is a typical characteristic were clearly observed (FIG. 3(c-f)), suggesting that the coating was formed by a hydrogel resulting from the crosslinks of the polymer. Compared with the PEI-decane-PEGMA (1:10:2) coating, the network of the PEI-decane-PEGMA (1:10:4) is more homogeneous, which agrees well with the results of the samples dried under oven. The network structure of the coating would disappear according to further increase in the PEGMA content, for example, PEI-decane-PEGMA (1:10:8) and PEI-decane-PEGMA (1:10:16) coating (FIG. 3(e-f)), caused by the increase in crosslinks.

Antimicrobial Activity of PEI-Decane

As mentioned earlier, hydrophobic moieties play an important part in killing pathogens by inserting into the inner hydrophobic core of the pathogens membrane, resulting in cell death. Thus, the antimicrobial activity might be improved by the introduction of hydrophobic groups into the PEI backbone. To confirm whether the antimicrobial activity of PEI grafted with decane groups was improved, the MIC were investigated. The MIC values were summarized in Table 1. As shown in Table 1, compared to the original PEI, the MICs for bacterial decreased with the introduction of the decane groups, and PEI-decane (1:10) showed the lowest MIC among all molecules. However, the MIC for C. albicans remains high, suggesting that PEI and PEI-decane showed inferior antifungal activity. The introduction of decane groups also did not improve their effectiveness. This may be attributed to the poor interaction between C. albicans cell and the polymers in solution. Based on the MICs results, therefore, PEI-decane (1:10) was chosen as the backbone material for further studying or optimization.

Antimicrobial Activity of PEI-Decane-PEGMA

To determine whether PEGMA would affect the antimicrobial activity of PEI-decane, the MIC of PEI-decane-PEGMA was studied. It was found that the MIC was increased after grafting with PEGMA (Table 2).

TABLE 2
MIC of PEI-decane-PEGMA

| | | | Gram- | |
|---|---|---|---|---|
| | Gram-negative | | positive | Fungus |
| MIC (μg/ml) | E. coli | P. aeruginosa | S. aureus | C. albicans |
| PEI-decane- | 312 | 312 | 312 | 1250 |
| PEGMA (1:10:1) | | | | |
| PEI-decane- | 312 | 312 | 312 | 1250 |
| PEGMA (1:10:2) | | | | |
| PEI-decane- | 312 | 312 | 312 | 1250 |
| PEGMA (1:10:4) | | | | |
| PEI-decane- | 312 | 312 | 312 | 1250 |
| PEGMA (1:10:8) | | | | |
| PEI-decane- | 312 | 312 | 312 | 1250 |
| PEGMA (1:10:16) | | | | |

PEI-Decane-PEGMA Coating on Contact Lens

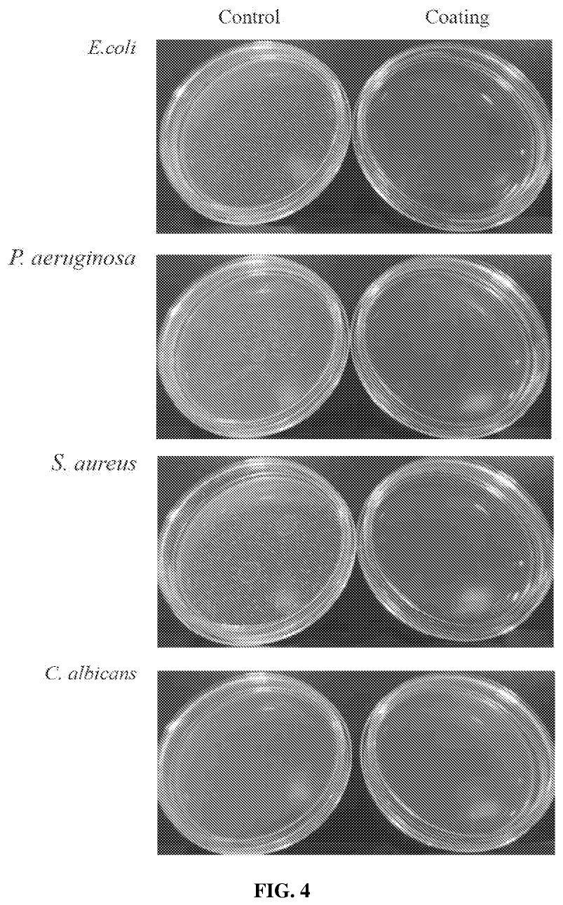

Having proven that PEI-decane-PEGMA coating was formed on contact lens, it was then investigated if the coating exhibited antimicrobial activity. Thus, the antimicrobial activity of PEI-decane-PEGMA was evaluated with bacterial and fungus. As shown in FIG. 4, compared with the control one, the pathogens on coating were not observed, indicating that bacterial were killed by contacting with the coating. Besides, the log reduction of the bacteria and fungus cell numbers and % kill were calculated. As listed in Table 3, the coating showed high log reduction of bacterial and fungus of more than 4, the % kill is larger than 99.99%. The results indicated that PEI-decane-PEGMA coating were highly effective and broad spectrum against Gram-negative, Gram-positive and fungus. It was also found that the antimicrobial activity of the PEI-decane-PEGMA coating was not affected by the PEGMA grafting.

TABLE 3
Antimicrobial activity of PEI-decane-PEGMA coating on contact
lens against Gram-negative/positive bacteria and fungus

| | Gram-negative | | | | Grant-positive | | Fungus | |
|---|---|---|---|---|---|---|---|---|
| | E. coli | | P. aeruginosa | | S. aureus | | C. albicans | |
| | | Log | | Log | | Log | | Log |
| Sample | % kill | reduction | % kill | reduction | % kill | reduction | % kill | reduction |
| PEI-decane-PEGMA | >99.99 | 4.14 | >99.99 | 4.297 | >99.99 | 4.08 | >99.99 | 4.11 |
| (1:10:1) | | | | | | | | |
| PEI-decane-PEGMA | >99.99 | 4.14 | >99.99 | 4.297 | >99.99 | 4.08 | >99.99 | 4.11 |
| (1:10:2) | | | | | | | | |
| PEI-decane-PEGMA | >99.99 | 4.14 | >99.99 | 4.297 | >99.99 | 4.08 | >99.99 | 4.11 |
| (1:10:4) | | | | | | | | |
| PEI-decane-PEGMA | >99.99 | 4.14 | >99.99 | 4.297 | >99.99 | 4.08 | >99.99 | 4.11 |
| (1:10:8) | | | | | | | | |
| PEI-decane-PEGMA | >99.99 | 4.14 | >99.99 | 4.297 | >99.99 | 4.08 | >99.99 | 4.11 |
| (1:10:16) | | | | | | | | |

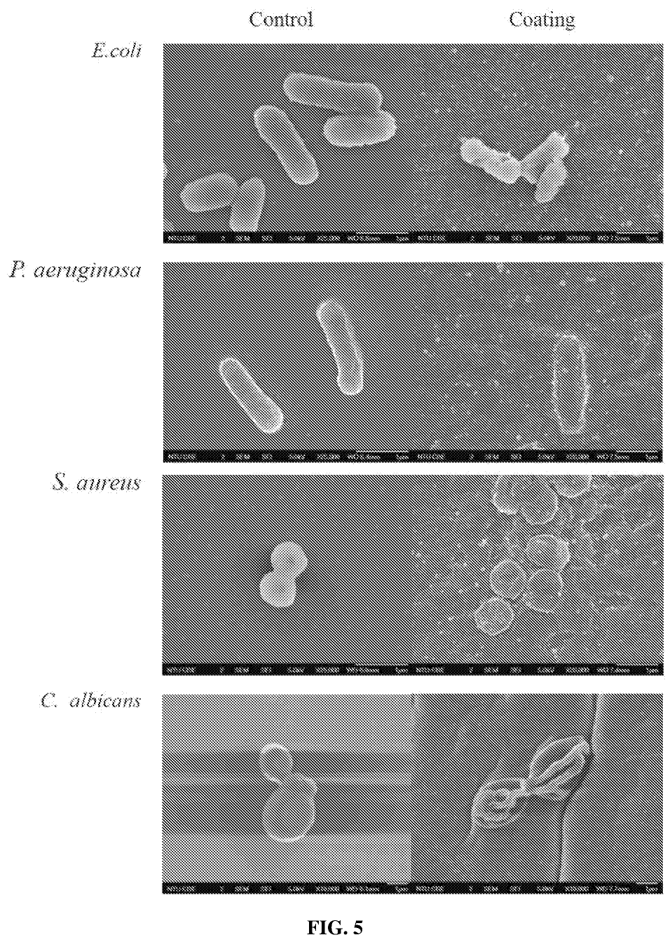

In order to get more direct information on bacterial on the coating, FESEM observations were performed to visualize the bacterial on coating after incubation for 1 h. As shown in FIG. 5, the pathogens on the PEI-decane-PEGMA coating exhibited obvious morphological changes compared to the controls. The surfaces of bacteria on control surfaces appeared smooth and rounded, whereas bacteria on the PEI-decane-PEGMA coating exhibited wrinkled and withered surfaces. These results could be expected since PEI-decane-PEGMA is a cationic polymer with positive charge and decane hydrophobic segments. PEI-decane-PEGMA is able to interact effectively with the anionic surface and hydrophobic cell membrane, thereby killing the microbes by adsorbing onto the microbes cell surface and perturbing the outer membrane of the cells, which leads to an abnormal distribution of the cytoplasm and damage to the microbes.

Conclusion

PEI was chosen as a backbone in order to develop a durable antimicrobial hydrogel coating. The PEI-modified by hydrophobic decane groups was carried out to improve its antimicrobial properties. The optimized PEI-decane (1:10) showed antimicrobial activity towards both Gram-negative and Gram-positive bacteria and fungus. Further modification was made to give the PEI-decane crosslinkable ability by grafting with PEGMA, forming PEI-decane-PEGMA. The synthesized PEI-decane-PEGMA was used to make a coating on contact lens by a plasma-UV method. This PEI-decane-PEGMA coating shows excellent broad spectrum antimicrobial activity, and the % kill and log reduction are higher than 99.99% and 4, respectively. The coating presented herein potentially opens up a path for forming coating on other implant, e.g. catheter.

### Example 2

In this example, a durable antimicrobial hydrogel coating for biomedical devices is developed by a combination of plasma treatment and UV photo-polymerization of polyethyleneimine-graft-polyethylene glycol methacrylate (PEI-PEGMA) and its alkylated form with an addition of decane groups (PEI-decane-PEGMA). These PEI-PEGMA and PEI-decane-PEGMA coatings show excellent broad spectrum antimicrobial activity towards both Gram-negative and Gram-positive bacteria and fungus. The % kill and log reduction of the hydrogels are higher than 99.99999% and 7.0 respectively. The hydrogels are biocompatible with human cells, as they are shown to have more than 95% of cell viability when tested against human dermal fibroblast (HDF) cells in vitro.

Materials and Methods

Materials

Branched polyethyleneimine (PEI, Sigma-Aldrich, Mₙ=10⁴, M_{w}/Mₙ=2.5) was lyophilized to dryness before use. 1-Bromodecane, sodium hydroxide, potassium carbonate, isopropanol, polyethylene glycol methacrylate (PEGMA, Mₙ=360) and Irgacure 2959 were purchased from Sigma-Aldrich Corp. and used as received. Chloroacetyl chloride, absolute ethanol, toluene and methylene chloride were purchased from Merck Pte Ltd (Singapore) and used without further purification. Poly(ethylene glycol) (1000) dimethacrylate (PEGDMA) was purchased from Polysciences, Inc.

Characterizations

¹H NMR spectra were recorded at 25° C. on a Bruker AV300 NMR spectrometer at 300 MHz. Chemical shifts (6) were reported in ppm with reference to the internal standard protons of tetramethylsilane (TMS). FESEM observation was held on a JSM-6701F (JEOL, Japan). Optical densities of bacteria suspensions and MTT were measured with Tecan Infinite 200 microplate reader.

Preparation of Chloro-Functionalized Polyethylene Glycol Methacrylate (Cl-PEGMA)

11.8 mL (35.3 mmol) of PEGMA was first dissolved in 100 mL of toluene, 11.25 mL (141.2 mmol) of chloroacetyl chloride was added into the solution and then stirred and refluxed for 24 h at 120° C. After the reaction, the solution was subjected to solvent evaporation and the concentrate was subsequently added with methylene chloride (100 mL) for dissolution. Potassium carbonate was then added and the mixture was stirred for 10 min. After filtration and solvent evaporation of the filtrate, the product was obtained.

Preparation of Polyethyleneimine Grafted with PEGMA (PEI-PEGMA)

PEI was grafted with various ratios of PEGMA and the process is briefly described as follows. For simplicity, PEI-PEGMA (1:5) is described as an example. 1 g of PEI was first dissolved in 10 mL of deionized water, and 0.4 mL of NaOH solution (1 M) was added. Then, Cl-PEGMA (0.2 g) in isopropanol (1 mL) was added to the solution in a dropwise manner. The mixture was reacted for 3 h with stirring at room temperature and then subjected to dialysis (MWCO 10344). The final product was gained via lyophilization.

Preparation of Alkylated Polyethyleneimine

PEI with different alkyl groups were prepared through an alkylation reaction by varying the 1-Bromodecane/PEI feed ratio (Scheme 1, Table 1).

The number of the polymer name means the feed ratio of 1-Bromodecane to PEI. A typical procedure for preparation of PEI-decane (1:10) was as follows: PEI (2.0 g, 0.2 mmol) was dissolved in 50 mL of absolute ethanol and was alkylated with 0.442 g of 1-Bromooctane (2 mmol) under reflux conditions for 24 h. The generated HBr was neutralized with 0.2 g of sodium hydroxide under the same conditions for an additional 24 h. After removing the solvent, the resulting residue was dissolved in water and dialyzed against distilled water for 4 days. The obtained product was freeze dried for 24 h to give the polymer PEI-decane (1:10). The other polymers with various grafting ratios were prepared by the similar procedure, and the detailed characterization results were given in FIG. 1. ¹H NMR for PEI-decane (1:10) (300 MHz, D₂O): δ=0.75-0.96 ppm (CH₃ in decane group), δ=0.96-1.6 ppm (CH₂ in decane group), δ=2.1-3.18 ppm (CH₂ in PEI).

Preparation of PEI-Decane Grafted with PEGMA (PEI-Decane-PEGMA)

The PEI-decane grafted with various ratios of PEGMA was performed as briefly described as follows. For simplicity, PEI-decane-PEGMA (1:10:4) is described as an example. 1 g of PEI-decane (1:10) was first dissolved in 10 mL deionized water, and 0.4 mL of NaOH solution (1M) was then added. Then Cl-PEGMA (0.16 g) in isopropanol (1 mL) was added to the solution in a dropwise manner. The mixture was reacted for 3 h with stirring at room temperature and then subjected to dialysis (MWCO 10344). The final product was gained via lyophilization.

Minimum Inhibitory Concentration (MIC)

The MIC was evaluated for antimicrobial susceptibility of antimicrobial polymers. Bacteria species such as E. coli (K12), S. aureus (newman), P. aeruginosa (PA01), and C. albicans (ATCC10231) were used in the MIC test. Bacteria were inoculated and developed in 5 mL of Mueller-Hinton broth (MHB, Fluka, Analytical grade for MIC test) at 37° C. under continuous shaking at 200 rpm to mid log phase. Then, mid log phase bacteria medium was used for the preparation of the dilute bacteria suspension to conduct the antimicrobial susceptibility test. A starting concentration of antimicrobial polymer used was 1000 μg/mL. Then, 12 serial two-fold dilutions of antimicrobial polymer solutions were made in 100 μL of MHB for each well of a sterile 96-well flat-bottomed microliter plate. Dilutions of antimicrobial agents in MHB provided the range between 1000 and 8 μg/mL. After that, each well was inoculated with 100 μL of dilute bacteria suspension which had optical density 0.0002 and the final inoculum of each well provided 5×10⁵ CFU/mL. The microliter plate was incubated in the incubator at 37° C. for 18 h. Microbial growth in each well was determined by measuring optical density of the suspension in each well with Biorad microplate spectrophotometer (Benchmarkplus) at 600 nm. Replicate measurements were conducted for each bacteria and concentration of antimicrobial agent. Positive control samples without antimicrobial agents and negative control samples without bacteria suspensions were applied in this experiment. MIC is evaluated as the lowest concentration of antimicrobial agent required to inhibit growth of the bacteria after 18 h of incubation.

Formation of PEI-PEGMA and PEI-Decane-PEGMA Hydrogels

PEI-PEGMA and PEI-decane-PEGMA hydrogels were formed using UV irradiation of the precursor hydrogel solution. Irgacure 2959, the UV initiator, was first dissolved in ethanol to make a 10% stock solution. Hydrogel solution containing the polymer, crosslinker (PEGDMA) and UV initiator (Irgacure 2959) were mixed and dissolved completely in deionized water in a 1.5 mL microtube. 0.5 mL of the hydrogel solution was transferred to a well of a 24-well plate. Then, the hydrogel solution was irradiated with UV light (at wavelength 365 nm and intensity of 10 mW cm⁻²) for 15 min for crosslinking to occur to form hydrogels. The hydrogel was washed in ethanol for three times and deionized water for three times with sonication to remove all unreacted precursors.

In Vitro Antimicrobial Assay of Hydrogels

(I) Preparation of Bacteria Medium

Bacteria strains were inoculated and dispersed in 4 mL of MHB media at 37° C. with continuous shaking at 220 rpm to mid log phase. 1 mL of bacteria suspension was added into a sterile microtube and MHB medium was removed by centrifugation, followed by decanting of the supernatant. Bacteria were washed with 1 mL of PBS thrice and the final bacteria suspension was prepared with 1 mL of PBS.

(2) Inoculation of Bacteria on Hydrogels

10 μL of bacteria suspension in PBS containing approximately 10⁷ CFU was inoculated onto the surface of hydrogels which was placed on a small tissue culture petri dish. The bacteria suspension was then spread evenly to cover the whole surface of the hydrogels. A control was done by inoculating bacteria on a small petri dish directly. The petri dishes were incubated at 37° C. for 2 h with 90% of relative humidity.

(3) Enumeration of Bacteria Count

1 mL of PBS was added to each tissue culture petri dish after incubation. 0.9 mL of PBS was added to each well of 24-well plate. Then, a series often-fold dilution of bacteria suspension was done and plated onto LB agar (LB broth with agar, Sigma). The plates were incubated at 37° C. in an incubator for 18 h and bacteria colonies were counted.

The log reduction and % kill results were evaluated as follows.

$$Log reduction = Log ( total CFU of control ) - Log ( total CFU on hydrogels )$$

$$\% kill = \frac{total CFU of control - total CFU on hydrogels}{total CFU of control} \times 100 \%$$

In Vitro Biocompatibility Assay of Hydrogels

The biocompatibility studies were carried out with human dermal fibroblasts (HDF). Cell culture media used were full DMEM which consisted of 10% fetal bovine serum (FBS) and 1% antibiotics (penicillin-streptomycin).

(I) Transwell MTT Assay

HDF cells were cultured in 24-well plates from an initial inocula of 5×10⁴ cells in each well, and incubated in a CO₂ incubator at 37° C. for 24 h for cell attachment. Approximately 5 mm diameter of the hydrogels were cut out and placed in transwell inserts (Falcon, 1 μm pores) before incubating with HDF cells at 37° C. for 24 h. Then, the hydrogels were removed and the culture media were replaced with MTT solution (1 mg/mL) and incubated at 37° C. for 4 h to stain viable cells. MTT solution was removed, dimethylsulfoxide (DMSO) was added and the plate was shaken at 150 rpm for 15 min. The cell viability was measured by the absorbance of each well at 570 nm, and was compared to the cell only control wells which serves as the 100% cell viability control.

(2) Contact MTT Assay

HDF cells were cultured in 96-well plates from an initial inocula of 1×10⁴ cells in each well, and incubated in a CO₂ incubator at 37° C. for 24 h for cell attachment. Approximately 5 mm diameter of the hydrogels were cut out and immersed in the cell culture and incubated at 37° C. for 24 h. Then, the hydrogels were removed and the culture media were replaced with MTT solution (1 mg/mL) and incubated at 37° C. for 4 h to stain viable cells. MTI solution was removed, DMSO was added and the plate was shaken at 150 rpm for 15 min. The cell viability was measured by the absorbance of each well at 570 nm, and was compared to the cell only control wells which serves as the 100% cell viability control.

Results were evaluated as follows:

$$Cell viability ( \% ) = \frac{Absorbance of hydrogel treated cells}{Absorbance of control cells } \times 100 \%$$

Surface Coating of PEI-Decane-PEGMA on Contact Lens

Contact lens A was provided by Clearlab company. The contact lens were first activated with argon plasma (March PX-500™, the conditions were 100 W, 400 mTorr and 120 s) and then exposed to air for 15 min to generate surface peroxide groups. The pretreated contact lenses were then immersed in 0.49 mL solution containing PEI-decane-PEGMA (10 wt %) and PEGDMA (5%), then irradiated by UV light (at wavelength 365 nm and intensity of 10 mW cm⁻²) for 15 min. After UV irradiation, the samples were taken out and washed with deionized water to remove un-grafted reactants and adsorbed homopolymers.

Antimicrobial Assay of PEI-Decane-PEGMA Surface Coatings

(1) Preparation of Bacteria Medium

Bacteria strains were inoculated and dispersed in 4 mL of MHB media at 37° C. with continuous shaking at 220 rpm to mid log phase. 1 mL of bacteria suspension was added into a sterile microtube and MHB medium was removed by centrifugation, followed by decanting of the supernatant. Bacteria were washed with 1 mL of PBS thrice and the final bacteria suspension was prepared with 1 mL of PBS.

(2) Inoculation of Bacteria on Coated Contact Lens

Contact lens was coated with the antimicrobial polymer. After coating, coated contact lens was washed with deionized water for five times. 10 μL of bacteria suspension in PBS (5×10⁸ CFU/mL) was distributed onto the surface of coated contact lens which was placed inside the tissue culture plate. Bacteria suspension without samples in the plate was used as a control. The plates were incubated at 37° C. for 1 h with 90% of relative humidity.

(3) Plate Counting of Bacteria

2 mL of PBS was added to each tissue culture plate after incubation. 900 L of PBS was inserted in each well of 24-well plate. Then, a series of 10-fold dilution of bacteria suspension was prepared and plating was prepared in LB agar media (LB broth with agar, Sigma). The plates were incubated at 37° C. in the incubator for 18 h and CFU were counted.

The log reduction and % kill results were evaluated as described in Example 1.

Microorganism Morphology Study

10 μL inoculum (5×10⁸ CFU/mL) of each pathogen was spread onto the contact lens surfaces and incubated for 1 h at 37° C. and a relative humidity of not less than 90%, then immediately fixed with glutaraldehyde (4.0%, 3 mL) solution for 4 h. The films were dehydrated by adding aqueous ethanol in a graded series (20%-100%) and then dried by a nitrogen flow. The microbes on the contact lens were observed by FESEM.

Formulation for Rub-Resistant Antimicrobial Coating

To improve coating formulations to resist failures caused by the applied normal load with fingers of users, crosslinker (the poly(ethylene glycol) diacrylate-PEGDA-molecular weight-700, Sigma-Aldrich) and monomer (2-hydroxyethyl methacrylate, 98%, molecular weight-130.14, ACROS Organics) were added to the antimicrobial polymer, PEI-decane-PEGMA. Composition of the formulation is as follows: Table 4.

TABLE 4
Formulated Hydrogel Compositions

| | Polymer content (% w/v) | Polymer content (% w/v) |
|---|---|---|
| Formulation | A | B |
| PEI-decane- | 10 | 10 |
| PEGMA (1:10:16) | | |
| PEGDA | 2.5 | 4 |
| HEMA | 2.5 | |
| AMPTMA | | 3 |
| Total mass | 15 | 17 |

The contact lens was treated with argon plasma for 2 min at 200 W and gas flow rate of 140 cc/min to form chemically reactive functionality on the contact lens. After treatment, the plasma-treated contact lens was exposed to air for 10 min to form peroxide on the surfaces of contact lens. Then, contact lens was immersed in the coating solution and irradiation was done with UV rays for 10 min to form coated contact lens.

In Vivo Wound Infection Mice Model

(1) Preparation of Hydrogel Wound Dressing

Hydrogel was formed as described above with a slight modification. 50 μL of hydrogel precursor solution was added to a 96-well plate and irradiated with UV light (at wavelength 365 run and intensity of 10 mW cm⁻²) for 15 min for crosslinking to occur to form hydrogel. The hydrogel was washed in ethanol for three times and deionized water for three times to remove all unreacted precursors. Then, the hydrogel was carefully scooped out of the well using a spatula and placed on a commercial transparent adhesive film (Opsite Flexifix, Smith & Nephew).

(2) Wound Infection Mice Model

Female Swiss Albino mice that were six weeks old and weighing approximately 20 g were used in the mice model. Wounding of the mice was done on Day 1. The mice were first anaesthetized using ketamine:xylazine cocktail via intraperitoneal injection. The fur on the dorsal part of the mice were shaven clean. Then, a circular cut-out of approximately 6 mm diameter of skin was excised from the dorsal part of the mice using a forceps and dissection scissors to create a wound. After that, approximately 10⁷ CFU of methicillin-resistant Staphylococcus aureus BAA-40 (MRSA) in 20 μL of PBS were inoculated on the wounded skin of the mice to simulate wound infection. The wound dressings were then applied onto the skin of the infected mice and observed for three days, with daily changing of the dressing. Control mice were treated with only the commercial transparent dressing (Opsite Flexifix, Smith & Nephew), while hydrogel treatment mice were treated with the PEI-PEGMA hydrogel dressing. Five mice were used in each group for the experiment.

(3) Enumeration of Bacteria Load on Wounded Skin

On Day 4, all mice were sacrificed by euthanasia using overdose of anesthetics followed by cervical dislocation. Each wounded skin was excised and homogenized in 1 mL of PBS by sonication for 15 min, followed by vortexing for 5 min. Then, a series often-fold dilution of bacteria suspension was done in PBS and plated onto LB agar (LB broth with agar, Sigma). The plates were incubated at 37° C. in an incubator for 18 h and bacteria colonies were counted.

The log reduction and % kill results were evaluated as follows.

$$Log reduction = Log ( total CFU of control ) - Log ( total CFU on hydrogels )$$

$$\% kill = \frac{total CFU of control - total CFU on hydrogels}{total CFU of control} \times 100 \%$$

Results and Discussion

Synthesis

The antimicrobial action of immobilized cationic polymers may be due to their ability to interact strongly with negatively charged phospholipids, allowing electrostatic interactions to govern initial binding to target cell membranes, and then the hydrophobic moieties on polymers interact with the inner hydrophobic core of the bacterial membrane resulting in a disruption in integrity and subsequent cell death. Thus, surface charge density and hydrophobicity are the main factors that affect antimicrobial activity of surface coatings. Since the pKa value of the imino group is approximately 10 to 11, PEI is a positively charged molecule in the physiological environment solutions (pH about 7.2).

To further improve its antimicrobial properties, hydrophobicity groups such as alkyl moieties are introduced into polymer backbone. Resorting to the alkylation reaction between 1-bromodecane and the amino groups on the PEI backbone, PEI grafted with various decane groups were prepared by changing the ratio of bromodecane/PEI. ¹H NMR was used to characterize PEI-decane. As shown in FIG. 1, the proton signals of PEI and decane groups are found in ¹H NMR spectrum. Based on the integral area of the protons of decane (about 0.7 to 0.9 ppm), in addition, it was found that the degree of grafted decane groups increases according to an increase in the feeding ratio, indicating that a series of PEI-decane with various decane groups were obtained.

To form stable coating on the surface of contact lens, PEI-decane needs to be grafted onto the contact lens covalently. A combination of plasma treatment and photo-polymerization at the contact lens surface is shown to be a suitable strategy for forming a stable coating on the contact lens. In order for photo-polymerization to take place, double bond groups need to be introduced in PEI-decane. Taking into account the biocompatible properties, PEGMA were introduced in PEI-decane by alkylation reaction between Cl-PEGMA and the amino groups of PEI-decane, forming PEI-decane-PEGMA.

To explore the effects of PEGMA contents upon the coating formation, PEI-decane-PEGMA with differing densities of PEGMA functions were prepared. ¹H NMR was used to characterize PEI-decane-PEGMA. As shown in FIG. 2, the signals of PEI-decane and PEGMA were observed, especially for the double bond protons at 5.58 ppm and 6.14 ppm, indicating that PEI-decane-PEGMA was prepared. Besides, the degree of grafted PEGMA increases as its feeding ratio increases.

Part I. Contact Lens Coating

Coating Formation on Contact Lens

To form a coating, the contact lens was first subjected to argon plasma treatment to generate peroxide groups on the surface of the contact lens. These peroxide groups were used as surface initiators in the UV initiated surface grafting polymerization (Scheme 2).

PEI-decane-PEGMA was used to make the surface coating on the Clearlab contact lens (A lens). In order to confirm the coating formation, FESEM observation was carried out (not shown) since it is a typical technique for characterizing surface morphology. The uncoated contact lens exhibits a smooth surface. However, the contact lens coated with PEI-decane-PEGMA show winkle surfaces, indicating that a thin layer of PEI-decane-PEGMA was immobilized on the surfaces of the contact lens.

Meanwhile, the coating formed by polymers with different PEGMA density was studied. It is found that the winkle coating becomes more and more homogenous with an increase in the content of PEGMA in PEI-decane-PEGMA. When the grafting degree of PEGMA is 4, i.e. PEI-decane-PEGMA (1:10:4), a homogenous coating is observed. If the grafting degree of PEGMA was further increased, the coating becomes compact, attributing to the higher crosslink degree.

To further observe the morphology of coating in water, the coated lenses were fixed by liquid nitrogen, and then freeze dried. Similar to the uncoated contact lens dried in oven, the uncoated contact lens also shows a smooth surface (FIG. 3(a)). For the contact lens coated by PEI-decane-PEGMA (1:10:1), the surface exhibits a bush structure (FIG. 3(b)), as the polymer was designed and synthesized to have only one PEGMA group per chain so that it formed a brush from the surface. With the increase in PEGMA content, the network structures which is a typical characteristic were clearly observed (FIG. 3(c-f)), suggesting that the coating was formed by a hydrogel resulting from the crosslinks of the polymer. Compared with the PEI-decane-PEGMA (1:10:2) coating, the network of the PEI-decane-PEGMA (1:10:4) is more homogeneous, which agrees well with the results of the samples dried under oven. The network structure of the coating would disappear according to further increase in the PEGMA content, for example, PEI-decane-PEGMA (1:10:8) and PEI-decane-PEGMA (1:10:16) coating (FIG. 3(e-f)), caused by the increase in crosslinks.

Antimicrobial Activity of PEI-Decane

As mentioned earlier, hydrophobic moieties play an important part in killing pathogens by inserting into the inner hydrophobic core of the pathogens membrane, resulting in cell death. Thus, the antimicrobial activity might be improved by the introduction of hydrophobic groups into the PEI backbone. To confirm whether the antimicrobial activity of PEI grafted with decane groups was improved, the MIC were investigated. The MIC values were summarized in Table 1. As shown in Table 1, compared to the original PEI, the MICs for bacterial decreased with the introduction of the decane groups, and PEI-decane (1:10) showed the lowest MIC among all molecules. However, the MIC for C. albicans remains high, suggesting that PEI and PEI-decane showed inferior antifungal activity. The introduction of decane groups also did not improve their effectiveness. This may be attributed to the poor interaction between C. albicans cell and the polymers in solution. Based on the MICs results, therefore, PEI-decane (1:10) was chosen as the backbone material for further studying or optimization.

Antimicrobial Activity of PEI-PEGMA and PEI-Decane-PEGMA

To check whether PEGMA would affect the antimicrobial activity of PEI and PEI-decane, the MIC of PEI-PEGMA and PEI-decane-PEGMA were tested. It was found that the MIC was increased after grafting with PEGMA (Table 5).

TABLE 5
MIC of PEI-PEGMA and PEI-decane-PEGMA

| | | | Gram- | |
|---|---|---|---|---|
| | Gram-negative | | positive | Fungus |
| MIC (μg/ml) | E. coli | P. aeruginosa | S. aureus | C. albicans |
| PEI-PEGMA (1:5) | 512 | 32 | 16 | — |
| PEI-PEGMA (1:10) | — | 64 | 32 | — |
| PEI-PEGMA (1:20) | — | 64 | 32 | — |
| PEI-decane- | 128 | 256 | 64 | 1250 |
| PEGMA (1:10:1) | | | | |
| PEI-decane- | 128 | 256 | 64 | 1250 |
| PEGMA (1:10:2) | | | | |
| PEI-decane- | 128 | 256 | 64 | 1250 |
| PEGMA (1:10:4) | | | | |
| PEI-decane- | 128 | 256 | 64 | 1250 |
| PEGMA (1:10:8) | | | | |
| PEI-decane- | 128 | 256 | 64 | 1250 |
| PEGMA (1:10:16) | | | | |

Having proven that PEI-decane-PEGMA coating was formed on contact lens, it was then investigated if the coating exhibited antimicrobial activity. Thus, the antimicrobial activity of PEI-decane-PEGMA was evaluated with bacterial and fungus. As shown in FIG. 4, compared to the control, the bacteria on coating cannot be observed, indicating that bacteria were killed on contact with the coating. Besides, the log reduction of the bacteria and fungus cell numbers and % kill were calculated. As listed in Table 4, the coating showed high log reduction of bacterial and fungus more than 4, the % kill was larger than 99.99%. The results indicated that PEI-decane-PEGMA coating are highly effective and broad spectrum against Gram-negative, Gram-positive and fungus. It was also found that the antimicrobial activity of the coating was not affected by the PEGMA grafting.

In order to get more direct information on bacterial on the coating, FESEM observations were performed to visualize the bacterial on coating after incubation for 1 h. As shown in FIG. 5, the pathogens on PEI-decane-PEGMA coating exhibit obvious morphological changes compared with the controls. The surfaces of bacteria on control surfaces appear smooth and rounded, whereas bacteria on PEI-decane-PEGMA coating exhibit wrinkled and withered surfaces. These results could be expected since PEI-decane-PEGMA is a cationic polymer with positive charge and decane hydrophobic segments. PEI-decane-PEGMA is able to interact effectively with the anionic surface and hydrophobic cell membrane, thereby killing the microbes by adsorbing onto the microbes cell surface and perturbing the outer membrane of the cells, which leads to an abnormal distribution of the cytoplasm and damage to the microbes.

Rubbing-Resistant Coating Formulations A and B

To improve coating formulations to resist failures caused by the applied normal load with fingers of users, crosslinker (the poly(ethylene glycol) diacrylate-PEGDA-molecular weight-700, Sigma-Aldrich) and monomer (2-hydroxyethyl methacrylate, 98%, molecular weight-130.14, ACROS Organics) were added to the antimicrobial polymer, PEI-decane-PEGMA.

Composition of formulation A is shown in Table 3. Contact lens was treated with argon plasma for 2 min at 200 W and gas flow rate of 140 cc/min to form chemically reactive functionality on the contact lens. After treatment, the plasma-treated contact lens was exposed to air for 10 min to form peroxide on the surfaces of contact lens. Then, the contact lens was immersed in the coating solution and irradiation was done with UV rays for 10 min to form coated contact lens. Antibacterial activity of coated contact lens was tested with 1×10⁷ CFU of E. coli. The control group (non-coated contact lens) was observed to have E. coli bacteria 1.17×10⁷ CFU on the surface. Coated contact lens with formulation A seem to be effective for antibacterial activity with killing rate more than 99.99999% and log reduction around 7. Therefore, it might be concluded that incorporation of crosslinker PEGDA and monomer HEMA in the formulation might also be effective for antibacterial activity.

The coated contact lens was first immersed in a standard commercially available contact lens disinfectant solution placed in a commercially available contact lens' case. The contact lens was then removed from the case and rubbed for 10 s according to the manufacturer's instructions. After rubbing, the contact lens was replaced into the contact lens case with fresh disinfection solution. The rubbing cycle was repeated for 5 times and the antimicrobial effect was evaluated. Antibacterial activity of coated contact lens after 5 cycles of rubbing was tested with 1×10⁷ CFU of E. coli. The control group (non-coated contact lens) was observed to have E. coli bacteria 1.55×10⁷ CFU on the surface. Coated contact lens with formulation shown in Table 3 was observed to have 5×10³ CFU on the surface. Coating layer seems to have disintegration from the surface of contact lens during rubbing as log reduction was reduced from 7 to 3.49 though it has good log reduction of 3.49. In addition, during rubbing, softness of the coating layer was observed. Therefore, instead of HEMA, trimethyl acrylamidopropyl ammonium chloride was used for the next formulation B.

Antibacterial activity of coated contact lens was tested with 1×10⁷ CFU of E. coli. The control group (non-coated contact lens) was observed to have E. coli bacteria 8×10⁶ CFU on the surface. Coated contact lens with formulation B seems to be effective for antibacterial activity with killing rate more than 99.9999% and log reduction of 6.90. No viable cell was detected for contact lens coated with the formulation shown in Table 3. These observations suggest that the effect of PEI-decane-PEGMA, PEGDA (3-Acrylamidopropyl) trimethylammonium chloride on the contact lens is probably an inhibition of the adhesion of E. coli. FIG. 3 shows SEM pictures of contact lens coated with the different formulations. The pictures confirm that hydrogel porous network was on the surface of contact lens.

Antibacterial activity of coated contact lens was tested with 1×10⁷ CFU of E. coli. E. coli bacteria of 8×10⁶ CFU was detected on the surface of non-coated contact lens. Coated contact lens with formulation shown in Table 3 after 5 cycles of rubbing seems to maintain the same antibacterial activity with killing rate more than 99.9999% and log reduction of 6.90. No viable cell was detected for contact lens coated with the formulation shown in Table 3 after 5 cycles of rubbing. These observations suggest that PEI-decane-PEGMA, PEGDA (3-Acrylamidopropyl) trimethylammonium chloride improve resistance of sensitivity of functionalized polymers with the applied load of fingers. FIG. 3 shows SEM pictures of contact lens coated with the formulation shown in Table 3. The pictures confirm that hydrogel layer was stable on the surface of contact lens after 5 cycles of rubbing test.

The antimicrobial coaled contact lens after 10 cycles of rubbing resulted in more than 99.9999% killing rate in viable E. coli after exposure with completely inhibiting bacterial growth and log reduction of more than 6. This high antimicrobial efficacy of coating materials likely reflects the ability of these materials to resist failures of coatings from the substrate of contact lens. Significant reduction of bacteria was achieved for the coated lens as E. coli of 3.98×10⁶ CFU was observed on the surface of non-coated contact lens and no bacteria was detected for the coated lens after 10 cycles of rubbing test. Furthermore, the coated contact lens after 10 cycles of rubbing resulted in surfaces with an intricate porous morphology. Ten cycles of rubbing did not alter the morphology and the attachment of coating.

Part II: Antimicrobial Wound Dressing

Crosslinking of PEI-PEGMA and PEI-Decane-PEGMA Hydrogels

Both PEI-PEGMA and PEI-decane-PEGMA hydrogels were crosslinked using UV irradiation, as it is a fast and efficient method as compared to thermal and chemical crosslinking. Different weight percentages of monomers and crosslinkers to use in the gelation process were investigated in order to choose the best formulations for further study. Poly(ethylene glycol) (1000) dimethacrylate (PEGDMA) was used as the crosslinker. The formulations of the hydrogels were shown in Table 6.

TABLE 6
Formulations of PEI-PEGMA and PEI-decane-PEGMA hydrogels

| | | PEGDMA | Irgacure | |
|---|---|---|---|---|
| Formulation | Monomer (w/v) | (w/v) | 2959 (w/v) | Gelation |
| 2 | PEI-decane- | 5% | 0.1% | No |
| | PEGMA (5%) | | | |
| 3 | PEI-PEGMA (10%) | 5% | 0.1% | Poor gel |
| 4 | PEI-decane- | 5% | 0.1% | Poor gel |
| | PEGMA (10%) | | | |
| 5 | PEI-PEGMA (10%) | 10% | 0.1% | Stable gel |
| 6 | PEI-decane- | 10% | 0.1% | Stable gel |
| | PEGMA (10%) | | | |

Generally, a weight percentage of 5-10% of monomer and crosslinker was used to form the hydrogels. Formulations 1 and 2 (5% monomer, 5% PEGDMA) did not form hydrogels at all after exposing to UV light. Formulation 3 (10% PEI-PEGMA, 5% crosslinker) formed very soft hydrogels that disintegrated easily after immersing in water. Formulation 4 (10% PEI-decane-PEGMA, 5% PEGDMA) produced a good hydrogel. Formulations 5 and 6 (10% monomer, 10% PEGDMA) produced the best hydrogels for both PEI-PEGMA and PEI-decane-PEGMA, as the hydrogels were stable when immersed in water for long period of time. Formulations 5 and 6 were selected for further study as other formulations did not form proper hydrogels and the weight percentages of monomer and crosslinker are consistent for both PEI-PEGMA and PEI-decane-PEGMA.

In Vitro Antimicrobial Activities of Hydrogels

Hydrogels were tested for their contact active killing of bacteria with E. coli and S. aureus BAA-40 (MRSA). Both PEI-PEGMA and PEI-decane-PEGMA hydrogels showed very good bacterial killing of both strains of bacteria, killing all the bacteria that were inoculated on the surface of the hydrogels. As the control consisted of 1.16×10⁷ CFU of E. coli and 1.30×10⁷ CFU of MRSA, the log reduction of the bacteria can be calculated to be 7.06 for E. coli and 7.11 for MRSA for both hydrogels. Hence, the % kill of both bacteria was determined to be more than 99.99999% for both hydrogels.

Table 7 shows in vitro bacterial log reduction of PA01, CR-PA, A. baumannii, CR-AB, E. coli, K. pneumoniae, S. aureus and MRSA when incubated with PEI-PEGMA hydrogel and PEI-decane-PEGMA hydrogel. Approximately 10⁷ CFU of bacteria survived on the control after 2 h of incubation but none survived when incubated with PEI-PEGMA and PEI-decane-PEGMA hydrogels. This corresponds to a more than 7 log reduction of bacteria or more than 99.99999% killing of bacteria by both hydrogels as compared to the control.

| | Hydrogel formulation | |
|---|---|---|
| Hydrogel bactericidal activity | PEI-PEGMA | PEI-decane-PEGMA |
| Bacteria | Bacterial log reduction | |
| PA01 | 7.31* | 7.31* |
| CR-PA | 7.63* | 7.63* |
| A. baumannii 19606 | 7.55* | 7.55* |
| CR-AB | 7.33* | 7.33* |
| E. coli 8739 | 7.12* | 7.12* |
| K. pneumoniae 13883 | 7.13* | 7.13* |
| S. aureus 29213 | 7.35* | 7.35* |
| MRSA USA300 | 7.52* | 7.52* |

Table 7 shows in vitro bacterial log reduction of PA01, CR-PA, A. baumannii, CR-AB, E. coliy K. pneumoniae, S. aureus and MRSA when incubated with PEI-PEGMA hydrogel and PEI-decanc-PEGMA hydrogel.

This result showed that both hydrogels were very effective in killing bacteria in the contact mode. It is postulated that the hydrogels were able to kill all bacteria due to the highly branched nature of PEI that consisted of many cationic amino groups in the network of the hydrogels. The cationic groups in the hydrogel network were able to “suck” in bacteria by electrostatic interactions and subsequently destroyed the bacterial cell wall to kill the bacteria.

In Vitro Biocompatibility of Hydrogels

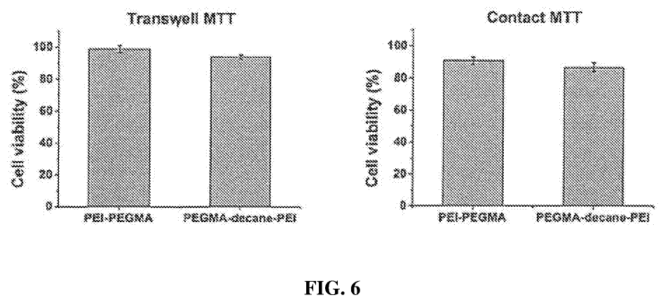

Hydrogels were tested for their biocompatibility with HDF cells. Transwell MTT assay was used as a measure of the leaching of the hydrogels, as they are usually toxic and will decrease the viability of cells. Contact MTT assay was used to determine the contact compatibility of the hydrogels with cells. For transwell MTT, both hydrogels (PEI-PEGMA and PEI-decane-PEGMA) showed more than 95% of cell viability of HDF cells (FIG. 6). This meant that the hydrogels did not have much leaching of their contents, and might be concluded that the hydrogels were stable and properly crosslinked. For contact MTT, both hydrogels showed more than 85% of cell viability of HDF cells. This meant that the hydrogels are compatible upon contact with cells and does not induce any contact toxicity to the cells. These results proved that the hydrogels are very biocompatible with HDF cells, and might be used as a coating in biomedical devices.

Swelling Kinetics of Hydrogels

The swelling kinetics of the hydrogels were studied to determine the speed of swelling as well as the extent of swelling that the hydrogels are capable of. The hydrogels were weighed at time zero as well as different time points after immersing in copious amount of water. Hydrogels were properly dried with filter paper before measuring for their mass. The swelling ratio at certain time points was determined by the formula below.

$$Swelling ratio ( time = t ) = \frac{mass ( time = t ) - mass ( time = 0 )}{mass ( time = 0 )}$$

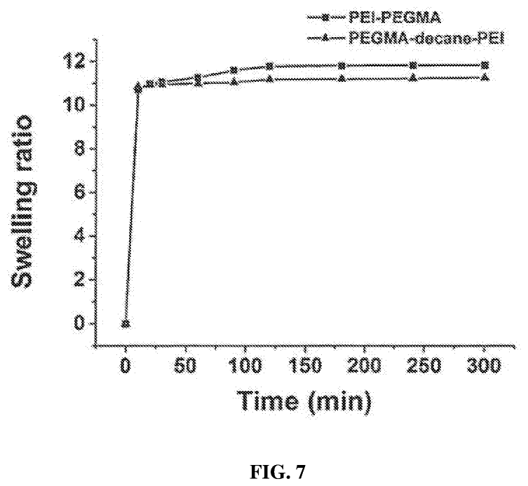

The data was then plotted as a line graph as shown in FIG. 7. It can be seen that both hydrogels swelled very rapidly, reaching the maximum swelling after only 10 min, which is the first time point. This is an exceptional quality of the hydrogels because they can absorb water very quickly. It is also important for the hydrogels to swell rapidly because it would be able to absorb wound exudate quickly and keep the wound area moist, which is crucial in the wound healing process. It is postulated that the hydrogels were able to swell so rapidly because of the high cationic charge due to the many amino groups of PEI, which attracts water very quickly. Also, the hydrogels were able to swell up to more than ten times its original mass.

In Vivo Wound Infection Mice Model

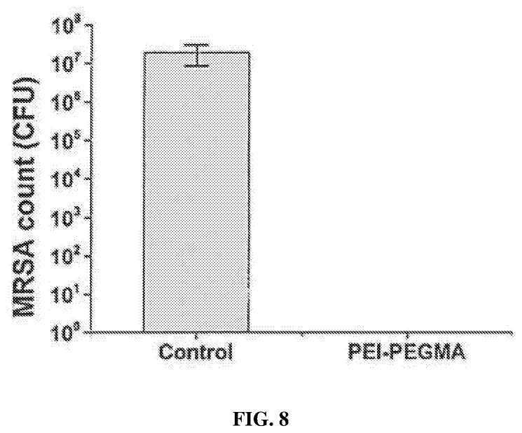

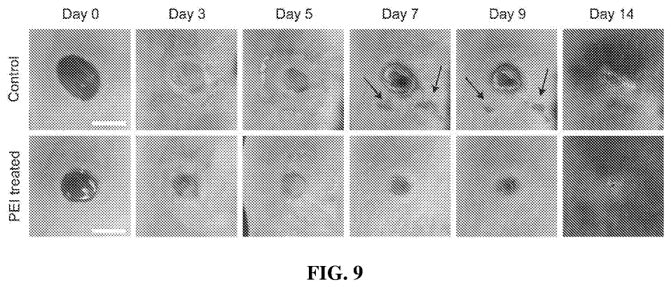

Due to the many similarities between both PEI-PEGMA and PEI-decane-PEGMA hydrogels in terms of their bacterial killing ability, in vitro biocompatibility and swelling kinetics, PEI-PEGMA hydrogel was chosen for in vivo study because it requires fewer and simpler synthesis steps. Approximately 10⁷ CFU of MRSA was inoculated on the wounded skin of each mouse. The bacteria was plated and was determined to contain 1.60×10⁷ CFU of MRSA. Next, control and hydrogel dressing were applied on the mice and changed daily for three days. On Day 4, all mice were euthanized and wounded skin were enumerated for CFU count. The average count of MRSA on the control mice was determined to be 1.93×10⁷ CFU (FIG. 8), which was slightly higher than the initial inocula that was infected on the wounded skin on Day 1. The average count of MRSA on the PEI-PEGMA hydrogel treated mice was determined to be zero after plating. This meant that the PEI-PEGMA hydrogel dressing was able to reduce the viable bacteria count by an order of 7.28 as compared to the control dressing. This equates to an effective killing of more than 99.99999% of MRSA. The in vivo log reduction result was similar to the in vitro test, where all bacteria were killed by the hydrogel. Moreover, the wounds of the hydrogel treated mice were cleaner and slightly smaller than the control mice after three days (FIG. 9).

Conclusion

PEI was chosen as a backbone to develop an antimicrobial hydrogel, due to its highly branched nature and containing many cationic amine groups. The PEI was modified by grafting PEGMA groups and was able to crosslink to form a hydrogel. Further alkylation of the PEI with hydrophobic decane groups was carried out to improve its antimicrobial properties. However, for the in vitro antimicrobial test, the PEI-PEGMA hydrogel was able to perform as good as the PEI-decane-PEGMA hydrogel, killing all bacteria that was inoculated on the surface. The transwell and contact MTT of both hydrogels were also very similar, suggesting that the hydrogels are very biocompatible and suitable to be used in biomedical applications. The synthesized PEI-decane-PEGMA was used to make a coating on contact lens by a plasma-UV method. This PEI-decane-PEGMA coating shows excellent broad spectrum antimicrobial activity, and the % kill and log reduction are higher than 99.99% and 4, respectively. For wound dressing, the mice model results were in tandem with the in vitro results, with PEI-PEGMA hydrogel killing all of the bacteria inoculated on the wounded skin. The antimicrobial hydrogels presented herein were proven to be very effective for use as an antimicrobial for infected wounds. This hydrogel can also potentially be explored in other biomedical applications, e.g. forming hydrogel coatings to combat many implant related infections.

### Example 3

In this example, a non-leachable, cationic polymer based hydrogel for managing wound infection is developed by the UV photo-polymerization of polyethylenimine-graft-polyethylene glycol methacrylate (PEI-PEGMA), followed by 2 h sonication in ethanol and water to remove the residual monomers. A UV-vis absorbance test supported the non-leachable conclusion as no signal was detected from the solution soaked with the hydrogel for 24 h (100 mg hydrogel in 5 mL water), whereas a peak can be observed at 200 nm even at low concentration of 1 μg/mL of the hydrogel polymer.

In a biofilm infection model to compare the efficacy of the hydrogel with commercial antimicrobial wound dressings (Allevyn Ag and Algisite Ag, Smith & Nephew), PEI hydrogel performed better by killing 4 log orders (more than 99.99%) of Methicillin-resistant Staphylococcus aureus (MRSA USA300) whereas the commercial antimicrobial dressings only reduced the bacteria count by one log order (more than 90%). Also, the hydrogel showed 6+ order (more than 99.9999%) killing of MRSA USA300 and 4+ order (more than 99.99%) killing of Pseudomonas aeruginosa (PA01) in infected (10⁷ CFU) full-excisional skin wound in a prophylactic mice model. The hydrogel is also non-inflammatory and non-pyrogenic, as it significantly reduces the number of inflammatory cells in infected mice skin to a non-infected wounded level. The hydrogel is biocompatible with human cells as it is shown to have more than 95% of cell viability when tested against human dermal fibroblast (HDF) cells in vitro. The hydrogel also has a very fast swelling kinetics which is important in wound treatment as they absorb the wound exudate quickly and keep the wound area moist. The hydrogel's in vitro and in vivo functional properties underscored the superiority of hydrogel as a wound dressing for infected wound, which is an important cause of morbidity and mortality.

Materials And Methods

Materials

Branched polyethylenimine (PEI, Sigma-Aldrich, M_{w}=800, 25,000 and 750,000) was lyophilized to dryness before use. 1-Bromodecane, sodium hydroxide, potassium carbonate, isopropanol, polyethylene glycol methacrylate (PEGMA, Mₙ=360) and 2-hydroxy-4′-(2-hydroxyethoxy)-2-methylpropiophenone (Irgacure 2959) were purchased from Sigma-Aldrich and used as received. Chloroacetyl chloride, absolute ethanol, toluene and methylene chloride were purchased from Merck Pte Ltd (Singapore) and used without further purification. Poly(ethylene glycol) (1000) dimethacrylate (PEGDMA) was purchased from Polysciences, Inc.

Characterizations

¹H NMR spectra were recorded at 25° C. on a Bruker AV300 NMR spectrometer at 300 MHz. Chemical shifts (δ) were reported in parts per million (ppm) with reference to the internal standard protons of tetramethylsilane (TMS). Optical densities of bacteria suspensions and MTT assay were measured with Tecan Infinite 200 microplate reader. Zeta potential readings were taken with Malvern Nano-ZS Particle Sizer. SEM images were taken with JEOL JSM-6701 FE-SEM. Confocal images were taken with ZEISS LSM 800. Compressive strength of hydrogels were tested with Instron 5543 Tensile Meter. Contact angles were measured with FTA200 Contact Angle Analyzer. UV-vis absorbance were measured with Thermo Evolution 600 BB.

Preparation of Chloro-Functionalized Polyethylene Glycol Methacrylate (Cl-PEGMA)

11.8 mL (35.3 mmol) of polyethylene glycol methacrylate (PEGMA) was first dissolved in 100 mL of toluene, 11.25 mL (141.2 mmol) of chloroacetyl chloride was added into the solution and then stirred and refluxed for 24 h at 120° C. After the reaction, the solution was subjected to solvent evaporation and the concentrate was subsequently added with methylene chloride (100 mL) for dissolution. Potassium carbonate was then added and the mixture was stirred for 10 min. After filtration and solvent evaporation of the filtrate, the product was obtained.

Preparation of Polyethylenimine Grafted with PEGMA (PEI-PEGMA)

Polyethylenimine (PEI) of molecular weights 800, 25,000 and 750,000 were grafted with various ratios of PEGMA (Scheme 3).

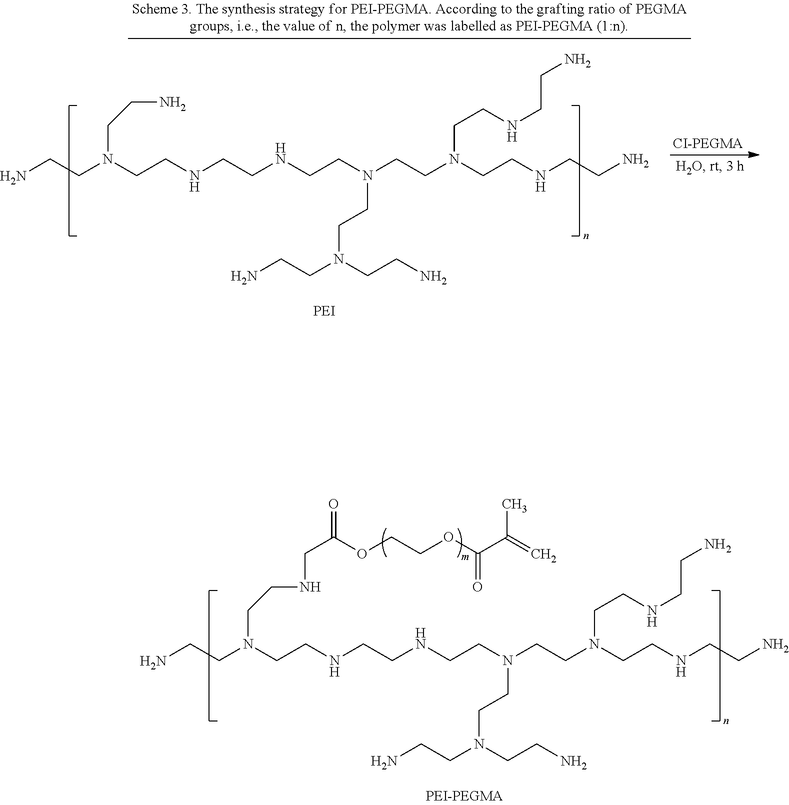

For simplicity, PEI(25K)-PEGMA (1:5) is described as an example. 1 g of PEI was first dissolved in 10 mL of deionized water, and 0.4 mL of NaOH solution (1 M) was added. Then, Cl-PEGMA (0.2 g) in isopropanol (1 mL) was added to the solution in a dropwise manner. The mixture was reacted for 3 h with constant stirring at room temperature and then subjected to dialysis (MWCO 10344) for three days. The final product was gained via lyophilization.

Preparation of Alkylated Polyethylenimine (PEI-Decane)

PEI (M_{w}=25,000) with decane groups were prepared through an alkylation reaction as described in Example 1. PEI (2.0 g, 0.2 mmol) was dissolved in 50 mL of absolute ethanol and was alkylated with 0.442 g of 1-Bromodecane (2 mmol) under reflux conditions at 85° C. for 24 h. The generated HBr was neutralized with 0.2 g of sodium hydroxide under the same conditions for an additional 24 h. After removing the solvent, the resulting residue was dissolved in water and dialyzed against distilled water for three days. The obtained product was freeze dried for 24 h to give the polymer decane-PEI.

Preparation of PEI-Decane Grafted with PEGMA (PEI-Decane-PEGMA)

1 g of PEI-decane was first dissolved in 10 mL of deionized water, and 0.4 mL of NaOH solution (1 M) was added. Then, Cl-PEGMA (0.64 g) in isopropanol (1 mL) was added to the solution in a dropwise manner. The mixture was reacted for 3 h with stirring at room temperature and then subjected to dialysis (MWCO 10344) for three days. The final product was gained via lyophilization.

Formation of PEI-PEGMA and PEI-Decane-PEGMA Hydrogels

PEI-PEGMA and PEI-decane-PEGMA hydrogels were formed using UV irradiation of the precursor hydrogel solution. Irgacure 2959, the UV initiator, was first dissolved in ethanol to make a 10% w/v stock solution. Hydrogel solution containing the polymer, crosslinker (PEGDMA) and UV initiator (Irgacure 2959) were mixed and dissolved completely in deionized water in a 1.5 mL microtube. 50 μL of the hydrogel solution was transferred to each well of a 96-well plate. Then, the hydrogel solution were irradiated with UV light (at wavelength 365 nm and intensity of 10 mW/cm²) for 10 min for crosslinking to occur to form hydrogels. The hydrogels were washed in ethanol for three times and deionized water for three times with sonication to remove all unreacted precursors. The formulations of hydrogels are given in Table 8. A 10% w/v of the polymer and PEGDMA appears to be needed to form stable hydrogels. Any lower percentage of either the polymer or PEGDMA may result in unstable hydrogel that degrades easily.

TABLE 8
Formulations of hydrogel compositions. PEGDMA =
polyethylene glycol dimethacrylate.

| | | PEGDMA | Irgacure 2959 | |
|---|---|---|---|---|
| Formulation | Polymer (w/v) | (w/v) | (w/v) | Gelation |
| 1 | 5% | 5% | 0.1% | No |
| 2 | 10% | 5% | 0.1% | Poor gel |
| 3 | 10% | 10% | 0.1% | Stable gel |

Minimum Inhibitory Concentration (MIC)

The MIC was evaluated for antimicrobial effectiveness of antimicrobial polymers. Bacteria species such as E. coli (ATCC8739), P. aeruginosa (ATCC27853), S. aureus (ATCC29213) and Methicillin-resistant S. aureus (MRSA USA300) were used in the MIC test. Bacteria were inoculated and dispersed in 4 mL of Mueller-Hinton broth (MHB, Fluka, Analytical grade for MIC test) at 37° C. under continuous shaking at 220 rpm to mid log phase. Then, mid log phase bacteria suspension was diluted in fresh MHB to conduct the antimicrobial test. A starting concentration of antimicrobial polymer used was 512 μg/mL. Then, ten serial two-fold dilutions of antimicrobial polymer solutions were made in 50 μL of MHB for each well of a sterile 96-well flat-bottomed microliter plate. Dilutions of antimicrobial agents in MHB provided the range between 512 and 1 μg/mL. After that, each well was inoculated with 50 μL of dilute bacteria suspension which had optical density of 0.0002 and the final inoculum of each well contained approximately 5×10⁵ CFU/mL of bacteria. The microliter plate was incubated at 37° C. for 18 h. Microbial growth in each well was determined by measuring the optical density (OD) of the suspension in each well with a microplate spectrophotometer (Tecan Infinite 200) at 600 nm. Replicate measurements were conducted for each bacteria and concentration of antimicrobial polymer. Positive control without antimicrobial agents and negative control without bacteria suspensions were applied in this experiment. MIC was evaluated as the lowest concentration of antimicrobial polymer required to inhibit the growth of bacteria after 18 h of incubation.

In Vitro Antimicrobial Assay of Hydrogels

(I) Preparation of Bacteria Medium

Bacteria strains (E. coli 8379, S. aureus 29213, PA01, MRSA USA300, K. pneumoniae 13883 and A. baumannii 19606) were inoculated and dispersed in 4 mL of MHB media at 37° C. with continuous shaking at 220 rpm to mid log phase. 1 mL of bacteria suspension was added into a sterile microtube and MHB medium was removed by centrifugation, followed by decanting of the supernatant. Bacteria were washed with 1 mL of PBS thrice and the final bacteria suspension was prepared with 1 mL of PBS.

(II) Inoculation of Bacteria on Hydrogels

10 μL of bacteria suspension in PBS containing approximately 1×10⁷ CFU were inoculated onto the surface of hydrogels which was placed on a small tissue culture petri dish. The bacteria suspension was then spread evenly to cover the whole surface of the hydrogels. A control was done by inoculating bacteria on a small petri dish directly. The petri dishes were incubated at 37° C. for 1 h with 90% of relative humidity.

(III) Enumeration of Bacteria Count

1 mL of PBS was added to each tissue culture petri dish after incubation and washed thoroughly. Hydrogels were immersed in PBS and vortexed to release the bacteria. 0.9 mL of PBS was added to each well of a 24-well plate. Then, a series of ten-fold dilution of bacteria suspension was done and plated onto LB agar (LB broth with agar, Sigma). The plates were incubated at 37° C. in an incubator for 18 h and bacteria colonies were counted.

The log reduction and % kill results were evaluated as follows.

$$Log reduction = Log ( total CFU of control ) - Log ( total CFU on hydrogels )$$

$$\% kill = \frac{total CFU of control - total CFU on hydrogels}{total CFU of control} \times 100 \%$$

Scanning Electron Microscopy to Visualize Hydrogel-Bacteria Interaction

A suspension of bacteria (MRSA USA300 and PA01, 1×10⁹ CFU/mL) in PBS was prepared followed by inoculation (10 μL, bacteria count=1×10⁷ CFU) on the hydrogels, after which they were incubated at 37° C. for 1 h. After incubation the bacteria were fixed on the hydrogels by dripping a small amount of glutaraldehyde fixative. The hydrogels were then freeze dried overnight before sectioning and sent for SEM imaging using JEOL JSM-6701 FE-SEM. A control was done by imaging hydrogel without bacteria.

LIVE/DEAD Assay to Examine Bacterial Viability and Membrane Permeabilization

LIVE/DEAD assay was carried out using hydrogel with PA01 and MRSA USA300. A suspension of bacteria (1×10⁹ CFU/mL) in PBS were prepared followed by inoculation (10 μL, bacteria count=1×10⁷ CFU) on the hydrogels, after which they were incubated at 37° C. for 1 h. After incubation the hydrogels were stained with BacLight bacterial viability kit L13152 (Invitrogen) for 15 min at room temperature. The green color SYTO 9 dye enters both intact and membrane compromised cells, while the red color propidium iodide dye can only enter membrane damaged cells, within which it reduces the green SYTO dye. The hydrogels were then imaged at the surfaces that were inoculated with bacteria with confocal microscopy (ZEISS LSM 800). A control was done by staining live bacteria.

Sol Content of Hydrogels

Hydrogel precursor solutions were irradiated with UV light for various time points (2, 4, 6, 8, 10 min) to crosslink. Then, hydrogels were freeze dried overnight and measured for their dry mass. The hydrogels were then washed thoroughly as described above and freeze dried overnight again before measuring for their dry mass after washing. The sol content of hydrogels were calculated using the formula as follows.

$$Sol content ( \% ) = \frac{initial dry mass - dry mass after washing}{initial dry mass}$$

Swelling Kinetics of Hydrogels

Hydrogels were investigated for their swelling kinetics in the following way. Newly made hydrogels were washed as described above and lyophilized to dryness. The mass of fully dried hydrogels were weighed at time zero. Then, copious amount of deionized water was added to the hydrogels to induce swelling. The mass of the swelled hydrogels were taken at 5, 10, 15, 20, 25 and 30 min time points after drying with filter paper.

Swelling ratio was calculated using the formula as follows.

$$Swelling ratio = \frac{\begin{matrix}mass of hydrogel at {n}^{th} min - \\ initial mass of hydrogel\end{matrix}}{initial mass of hydrogel}$$

Compression Test

The mechanical properties of the hydrogels were also characterized by compressive stress-strain measurements which were performed on swollen gels using an Instron 5543 Single Column Testing System. The cylindrical gel sample, 6 mm in diameter and 2 mm in thickness, was put on the lower plate and compressed by the upper plate, which was connected to a load cell, at a strain rate of 0.1 mm/min. Four parallel samples per measurement were performed, and the obtained values were averaged and plotted in a graph.

Surface Zeta Potential of Hydrogels

Hydrogels were characterized for their surface zeta potential using Malvern Nano-ZS Particle Sizer. Briefly, hydrogels were crushed using mortar and pestle and freeze dried overnight. The dried hydrogels were then crushed again into powder form and dispersed in water. The dispersions were then sent for zeta potential measurements.

Hydrogel Leaching Tests

Hydrogels were washed thoroughly as described previously before testing for their leachability. The washed hydrogels were then immersed in 5 mL of deionized water for 24 h before measuring the UV-vis absorbance of the solution using Thermo Evolution 600 BB UV-vis spectrophotometer. Control was done by measuring the UV-vis absorbance of the respective polymers at 100, 10 and 1 μg/mL concentration.

Wavelengths measured were 190-400 nm.

In Vivo Wound Infection Mice Model

(I) Wounding Experiment and FACs Analysis

Female C57BL/6 mice of about 7-8 weeks of age were used. The hair follicle cycle of each mouse was synchronized by depilating the back of the animal two weeks before starting the experiment. Mice were anaesthetized, depilated and two 6 mm diameter full-thickness excisional wounds were inflicted on the dorsal skin and the underlying panniculus carnosus. Next, 1×10⁷ of indicated bacteria (MRSA USA300 and PA01) in 20 μL of PBS was topically inoculated onto the wounds and left to settle for 10 min to simulate an infection. Hydrogels were applied on the wounds and secured with Tegaderm (3M) transparent dressing. Untreated infected and uninfected wounds served as controls. After 48 h post injury, the wound including 5 mm of the peripheral region was excised. Single-cell suspensions from wound samples were obtained using gentleMACS Dissociator according to the manufacturer's protocol (Miltenyi Biotec). Cells were immuno-labelled with CD11b and Ly6G (Biolegends) and flow cytometry was carried out using Accuri C6 flow cytometer (BD Biosciences). Data analysis was performed using Flowjo software version 7.6.5 (Tree Star). The mean percentage values (n=4-6) were plotted for each treatment, ±SEM. A two-tailed Student's t test was used for comparison. All animal studies were approved and performed in compliance with the regulations of the Institutional Animal Care and Use Committee of Nanyang Technological University.

(II) Enumeration of Bacteria Load on Wounded Skin

After 48 h post injury, the wound including 5 mm of the peripheral region was excised. Each wound was homogenized in 1 mL of PBS to release the bacteria (n=4). Then, a series of ten-fold dilutions of bacteria suspension was done in PBS and plated onto LB agar (LB broth with agar, Sigma). The plates were incubated at 37° C. for 18 h and bacteria colonies were counted.

The log reduction and % kill results were plotted and evaluated as follows.

$$Log reduction = Log ( total CFU of control ) - Log ( total CFU on hydrogels )$$

$$\% kill = \frac{total CFU of control - total CFU on hydrogels}{total CFU of control} \times 100 \%$$

(III) Comparison with Commercial Silver Dressings

Wounding and infection was done with the same procedure as above with a slight difference to the duration. After infection with bacteria, the mice were left for 24 h without treatment to simulate a biofilm infection, after which they were treated with their respective treatments for 24 h. Commercial antimicrobial wound dressings used were Allevyn Ag and Algisite Ag, both from Smith & Nephew. Then, the wound including 5 mm of the peripheral region was excised. Each wound was homogenized in 1 mL of PBS to release the bacteria (n=6). Then, a series often-fold dilutions of bacteria suspension was done in PBS and plated onto LB agar (LB broth with agar, Sigma). The plates were incubated at 37° C. for 18 h and bacteria colonies were counted.

The log reduction and % kill results were plotted and evaluated as follows.

$$Log reduction = Log ( total CFU of control ) - Log ( total CFU on hydrogels )$$

$$\% kill = \frac{total CFU of control - total CFU on hydrogels}{total CFU of control} \times 100 \%$$

(IV) Full Wound Healing Study

PEI hydrogel and MRSA USA300 bacteria were chosen for this study. At day 0, mice were wounded and infected with bacteria. The procedures of wounding and infection is the same as above. Untreated wound was secured with Tegaderm, while treated wounds were applied with PEI hydrogels before securing with Tegaderm. Photographs of the wounds were taken on days 0, 1, 3, 5, 7, 9, 12 and 14, at which the changing of fresh hydrogels also occur. At the same time points, mice were euthanized and sacrificed and had their wound harvested for bacteria counting (n=4). The bacteria count and wound size at each time point was determined. Wound sizes were calculated using the formula as follows:

$$Wound size ( \% ) = \frac{wound area on {n}^{th} day}{wound area on day 0} \times 100 \%$$

In Vitro Biocompatibility Assay of Hydrogels

The biocompatibility studies were carried out with human dermal fibroblasts (NHDF-Ad-Der Fibroblasts, CC2511, Lonza). Cell culture media used were full DMEM which consisted of 10% fetal bovine serum (FBS) and 1% antibiotics (penicillin-streptomycin).

(I) Transwell MTT Assay

HDF cells were cultured in 24-well plates from an initial inocula of 5×10⁴ cells in each well, and incubated in a CO₂ incubator at 37° C. for 24 h for cell attachment. 5 mm circular discs of the hydrogels were cut out and placed in transwell inserts (Falcon, 1 μm pores) before incubating with HDF cells at 37° C. for 24 h. Then, the hydrogels were removed and the culture media were replaced with MTT solution (1 mg/mL in DMEM) and incubated at 37° C. for 4 h to stain viable cells. MTT solution was removed, dimethylsulfoxide (DMSO) was added and the plate was shaken at 150 rpm for 15 min. The cell viability were measured by the absorbance of each well at 570 nm, and were compared to the cell only control wells which serves as the 100% cell viability control.

(II) Contact MTT Assay

HDF cells were cultured in 96-well plates from an initial inocula of 1×10⁴ cells in each well, and incubated in a CO₂ incubator at 37° C. for 24 h for cell attachment. Approximately 3 mm circular discs of the hydrogels were cut out and immersed in the cell culture and incubated at 37° C. for 24 h. Then, the hydrogels were removed and the culture media were replaced with MTT solution (1 mg/mL in DMEM) and incubated at 37° C. for 4 h to stain viable cells. MTT solution was removed, DMSO was added and the plate was shaken at 150 rpm for 15 min. The cell viability were measured by the absorbance of each well at 570 nm, and were compared to the cell only control wells which serves as the 100% cell viability control.

Results were evaluated as follows:

$$Cell viability ( \% ) = \frac{Absorbance of hydrogel treated cells}{Absorbance of control cells } \times 100 \%$$

Results and Discussion

In this example, two families of derivative PEI copolymers, specifically polyethylenimine-graft-polyethylene glycol methacrylate (PEI-PEGMA) and polyethylenimine-graft-decane-graft-polyethylene glycol methacrylate (PEI-decane-PEGMA), were synthesized and then formulated with a crosslinker (polyethylene glycol dimethacrylate, PEGDMA) and UV polymerized into microporous cationic hydrogels. The cationic PEI was grafted with PEGMA to allow the PEI-PEGMA to become UV-polymerizable. PEGMA not only bestowed the post-modification properties on PEI but may also improve the biocompatibility with mammalian cells. The effect of hydrophobicity on the hydrogels via PEI-decane-PEGMA was also studied. The optimized hydrogels achieved more than 7 order in vitro log reductions of various ESKAPE bacteria (Table 9).

TABLE 9
In vitro log reductions of different versions of PEI hydrogels against 6 strains of bacteria.

| | PEI(800)- | PEI(25K)- | PEI(750K)- | PEI(25K)- | PEI(25K)- | PEI(25K)- |
|---|---|---|---|---|---|---|
| | PEGMA | PEGMA | PEGMA | PEGMA | PEGMA | decane-PEGMA |
| Bacteria | (1:5) | (1:5) | (1:5) | (1:10) | (1:20) | (1:10:16) |
| E. coli 8739 | 1.45 | 7.12* | 7.12* | 6.72 | 5.52 | 7.12* |
| S. aureus 29213 | 2.56 | 7.35* | 7.35* | 7.35 | 7.35 | 7.35* |
| PA01 | 0.23 | 7.31* | 7.31* | 6.37 | 5.55 | 7.31* |
| MRSA USA300 | 0.45 | 7.52* | 7.52* | 7.52 | 7.52 | 7.52* |
| K. pneumoniae 13883 | 0.77 | 7.13* | 7.13* | 6.35 | 5.55 | 7.13* |
| A. baumannii 19606 | 0.68 | 7.55* | 7.55* | 6.10 | 5.60 | 7.55* |

*denotes that no bacteria colony was observed on the petri dish after plating for 18 h.

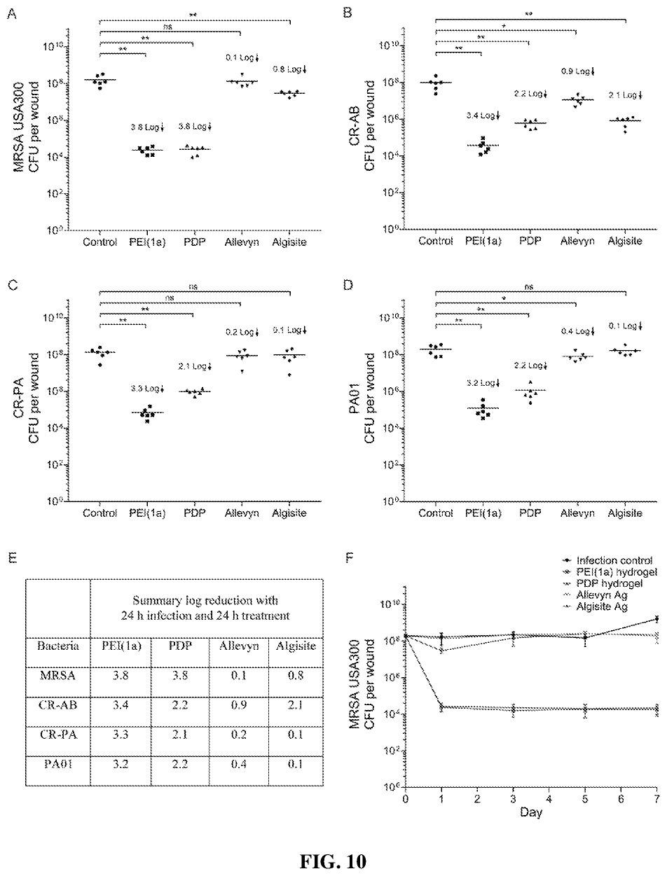

The in vivo log reductions of a prophylactic wound infection mice model against Methicillin-resistant S. aureus (MRSA USA300) and P. aeruginosa (PA01) which are clinically relevant for wound infection, are more than 6 and 4, respectively (FIG. 10), showing that the hydrogels have excellent broad-spectrum in vivo antimicrobial activity. Further, mice treated with PEI hydrogel displayed lower inflammation in the skin than infected control mice. Moreover, the hydrogels did not contain any leachable components nor silver commonly used in today's antibacterial wound dressings. Present technology is based on a highly microporous cationic hydrogel that disrupts the cell envelope of bacteria that comes in contact with the hydrogel.

For the PEI-PEGMA copolymer series, the molar ratios of PEI to PEGMA were varied from 1:5, 1:10 and 1:20 using PEI with molecular weight (M_{w}) of 25K; five PEI(M_{w})-PEGMA (x:y) copolymers with different molar ratios of x moles of PEI to y moles of PEGMA were made: (1) PEI(25K)-PEGMA (1:5); (2) PEI(25K)-PEGMA (1:10); (3) PEI(25K)-PEGMA (1:20); (4) PEI(800)-PEGMA (1:5); and (5) PEI(750K)-PEGMA (1:5). The decane derivative of PEI(25K)-decane-PEGMA (1:10:16) was made to study the effect of hydrophobicity. ¹H NMR (not shown) was used to verify the compositions. The doublets at 5.58 ppm and 6.14 ppm are due to the protons in the methacrylate group, indicating that PEGMA was successfully grafted onto PEI and decane-PEI to form PEI-PEGMA and PEI-decane-PEGMA, respectively. The protons at about 0.7-0.9 ppm are due to decane indicating that PEI-decane-PEGMA was successfully made.

The minimum inhibitory concentrations (MIC) of various PEI-PEGMA and PEI-decane-PEGMA copolymer solutions against the Gram-negative E. coli and P. aeruginosa, and the Gram-positive S. aureus and Methicillin-resistant S. aureus (MRSA USA300) were measured (Table 10) and they were generally similar and in the range of 64-512 μg/mL for Gram negative bacteria and 32-64 μg/mL for Gram-positive bacteria, indicating moderate potency. The grafting of different ratios of PEGMA and decane onto PEI did not affect the MIC much in their solution forms.

TABLE 10
Minimum inhibitory concentration (MIC) of raw PEI polymers and
modified PEI hydrogel polymers. All units in μg/mL.

| | Gram-negative | | Gram-positive | |
|---|---|---|---|---|
| MIC (μg/mL) | E. coli | P. aeruginosa | S. aureus | MRSA |
| PEI(800) | 256 | 128 | 64 | 32 |
| PEI(25K) | 256 | 128 | 32 | 32 |
| PEI(750K) | 128 | 64 | 32 | 32 |
| PEI(800)-PEGMA | 256 | 64 | 64 | 64 |
| (1:5) | | | | |
| PEI(25K)-PEGMA | 512 | 128 | 32 | 32 |
| (1:5) | | | | |
| PEI(750K)-PEGMA | 256 | 64 | 32 | 32 |
| (1:5) | | | | |
| PEI(25K)-PEGMA | 512 | 128 | 32 | 32 |
| (1:10) | | | | |
| PEI(25K)-PEGMA | 512 | 256 | 64 | 64 |
| (1:20) | | | | |
| PEI(25K)-decane- | 128 | 128 | 32 | 32 |
| PEGMA (1:10:16) | | | | |

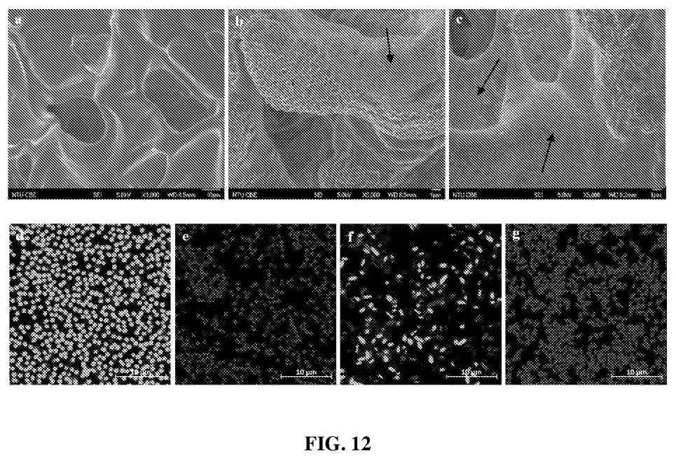

Hydrogels were made from an optimized formulation of 10% polymer with 10% cross-linker (PEGDMA) with a small percent (0.1%) photoinitiator (Irgacure 2959) in water. After UV irradiation, the solutions solidify into hydrogels with good mechanical integrity. The sol content data (FIG. 12) showed that 10 min of UV exposure was enough to crosslink the hydrogels, as they reached the minimum sol content at 8 min.

Hydrogels were tested for their contact active in vitro killing of lab strains E. coli and S. aureus, and many ESKAPE bacteria. The bacteria were inoculated on the surface of the hydrogels for 1 h and then plated to determine their viability. PEI(25K)-PEGMA (1:5), PEI(750K)-PEGMA (1:5) and PEI(25K)-decane-PEGMA (1:10:16) hydrogels were more effective as they killed all the bacteria, showing that higher M_{w} PEI and lower fraction of crosslinker increases the bactericidal properties. The in vitro log reductions of the bacteria were 7.52 for MRSA and 7.31 for PA01 for PEI(25K)-PEGMA (1:5), PEI(750K)-PEGMA (1:5) and PEI(25K)-decane-PEGMA (1:10:16) hydrogels. They also achieved more than 7 log reductions for other strains of bacteria tested. This result showed that higher M_{w} PEI hydrogels were very effective in killing bacteria in the contact mode, due to the highly branched nature of PEI that consisted of many cationic amino groups in the network of the hydrogels. The cationic groups in the hydrogel network were able to “suck” in bacteria by electrostatic interactions and then subsequently destroy the bacterial cell wall to kill the bacteria. PEI(800)-PEGMA (1:5) hydrogel achieved the lowest log reductions of bacteria, having less than one order of reduction for the ESKAPE strains.

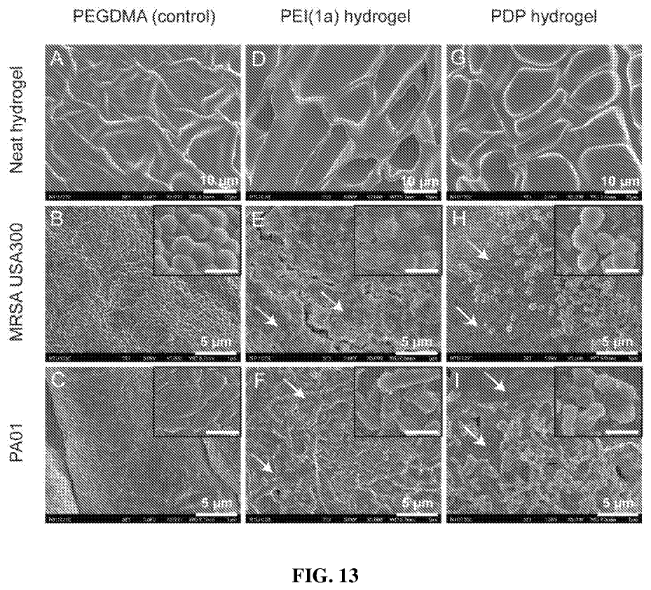

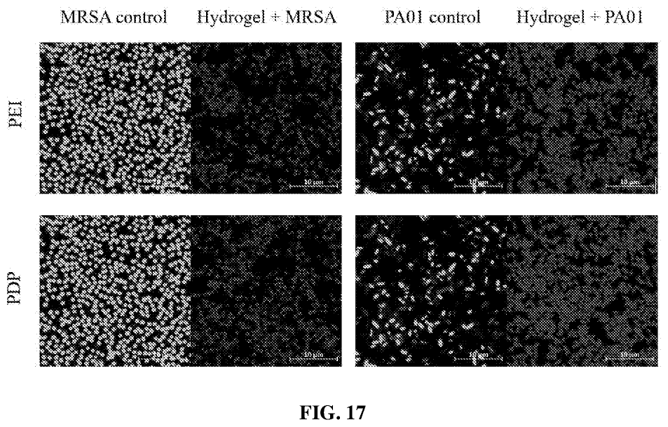

Scanning electron microscopy (SEM) and LIVE/DEAD assay were also done on the hydrogels and bacteria to further investigate and substantiate the results. From FIG. 12, it can be seen that PEI(25K)-PEGMA (1:5) hydrogel has a microporous structure that has pores bigger than 10 μm. When inoculated with bacteria, the bacteria were all stuck to the walls of the hydrogel and bacterial debris can be seen sticking to the hydrogel, signifying lysis of the bacteria to release their cellular contents. The same was observed for both MRSA and PA01. When bacteria were inoculated on the hydrogel and stained with LIVE/DEAD dye (FIG. 17), all bacteria that were inoculated on the hydrogels were stained red, meaning that the red dye propidium iodide had entered the bacterial cytoplasm. Since propidium iodide can only enter permeabilized membranes, it signified that the bacteria were all dead and have their membrane destroyed. The control have bacteria that were all stained green, signifying that they were all alive. The results were consistent for both MRSA and PA01. The hydrophobic PEI(25K)-decane-PEGMA (1:10:16) hydrogel has a slightly different structure but the mechanism of killing is the same as the other hydrogels (FIG. 13).

Hydrogels were tested for their biocompatibility with human dermal fibroblast (HDF) cells. Transwell MTT assay was used as a measure of the toxic leaching contents of the hydrogels, as they will decrease the viability of cells. Contact MTT assay was used to determine the contact biocompatibility of the hydrogels with cells. For transwell MTT, the cell viability of HDF cells were close to 100%, meaning that the hydrogels have no toxic leachable. For contact MTT, the cell viability of HDF cells were above 90%, which meant that the hydrogels are relatively biocompatible upon contact with cells and do not induce much contact toxicity to the cells. These results proved that the hydrogels are very biocompatible with HDF cells, which are found on the human skin, and more importantly comes with no toxic leachable, and hence are suitable to be used as a form of antimicrobial in wound dressings.

Two best hydrogel formulations were chosen for further characterizations, one of the PEI-PEGMA hydrogel and one PEI-decane-PEGMA hydrogel. PEI(25K)-PEGMA (1:5) and PEI(25K)-decane-PEGMA (1:10:16) hydrogels were chosen due to their superior in vitro antimicrobial activity and similar M_{w} of PEI. They are denoted as PEI and PDP hydrogels respectively, in the following paragraphs. The swelling kinetics of the hydrogels were studied to determine the speed of swelling as well as the extent of swelling that the hydrogels are capable of. The hydrogels were freeze dried overnight and weighed at time zero as well as at different time points (0, 5, 10, 15, 20, 25 and 30 min) after immersing in copious amount of water. Hydrogels were properly dried with filter paper before measuring their mass.

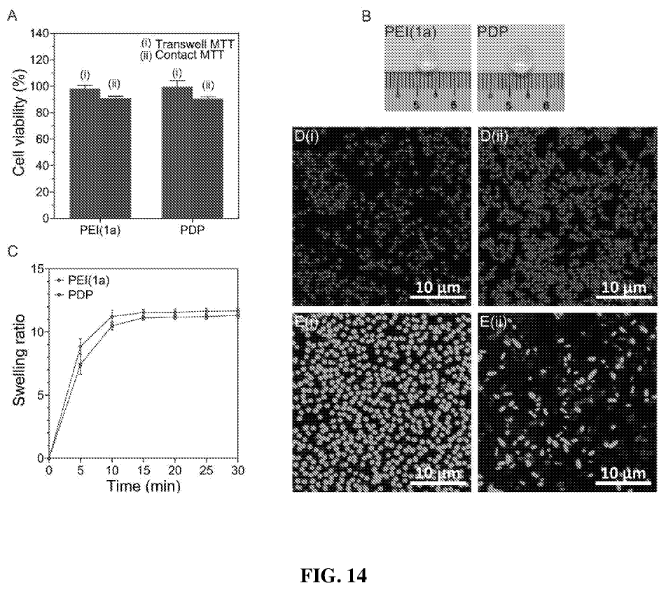

The swelling ratio at certain time points was determined by the formula found in the methods section. The data was then plotted as a line graph as shown in FIG. 14. The results showed that the hydrogels swelled very rapidly, reaching over 90% swelling after 10 min, and maximum swelling was reached after 15 min. This is an exceptional quality of the hydrogels because they can absorb water very quickly. It is also important for the hydrogels to swell rapidly because it will be able to absorb wound exudate quickly and keep the wound area moist, which is crucial in the wound healing process. It is postulated that the hydrogels were able to swell so rapidly because of the high cationic charge due to the many amino groups of PEI, and its subsequent high hydrophilicity, which attracts water very quickly. Also, the large pores of the hydrogels allow water to enter rapidly. The hydrogels were measured for their surface zeta potential, and they showed highly cationic charge on their surface. PEI hydrogel in particular had +64.5 mV charge on its surface, slightly higher than the surface charge on the hydrophobic PDP hydrogel (+54.7 mV). This highly positive charge allows the hydrogels to attract the negatively charged bacteria onto its surface before killing them by contact. Also, the hydrogels have good compressive strength as they can withstand more than 50% compression without breaking.

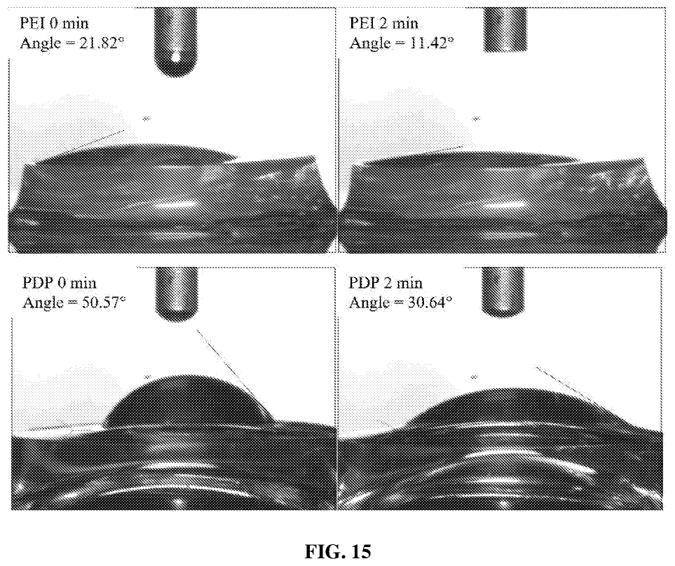

Contact angle measurements (FIG. 15) showed that PDP hydrogel is indeed more hydrophobic than PEI hydrogel as the contact angle of water was much higher for PDP hydrogel at both 0 min (50.57° for PDP, 21.82° for PEI) and 2 min (30.64° for PDP, 11.420 for PEI).

Leaching experiments performed on both hydrogels by measuring the absorbance of the hydrogel-soaked solution showed that the hydrogels have no leaching components, as they did not show any absorbance as opposed to their raw polymers which have an absorbance peak at 200 nm when measured at 100, 10 and 1 μg/mL (FIG. 14).

PEI and PDP hydrogels were tested with the mice model of infected skin wound due to their excellent in vitro antimicrobial activity and biocompatibility. MRSA USA300 and PA01 were used for the in vivo studies. These two strains of bacteria are clinically relevant in wound infections and are resistant to many current antibiotics, therefore studying them is of high importance. Approximately 1×10⁷ CFU of bacteria was inoculated on each of the wounded skin of the mice. The bacteria was plated and counted to contain 3.73×10⁷ CFU of MRSA and 1.22×10⁷ CFU of PA01. They were treated with control (Tegaderm), PEI and PDP hydrogels. On day two, all mice were euthanized and wounded skin tissues were dissociated for FACS and homogenized for bacteria load count. FACS analysis showed that the percentage of CD11b⁺ signals were non-significant for PEI hydrogel treated skin when compared with uninfected control for both strains of bacteria. Interestingly, PDP hydrogel treated skin showed an increase in CD11b⁺ signal, which was comparable to the value for infected control skin, for both MRSA and PA01 (FIG. 10). Since CD11b⁺ is a leukocyte-specific receptor, it is regarded as a marker for macrophages and granulocytes. These are immune response cells which causes inflammation. As such, PEI hydrogel was able to kill the bacteria as well as reduce inflammation in the skin, while PDP hydrogel could only do the former.

The average count of MRSA and PA01 on the control wounds were determined to be 1.60×10⁹ CFU and 2.23×10⁸ respectively, which were about 1-2 orders higher than the initial count that were inoculated on the wounds on Day 0. The average count of MRSA on the hydrogels treated wounds were 3.17×10² and 2.66×10² for PEI and PDP hydrogels respectively, and 3.83×10³ and 1.78×10⁴ for PA01. This meant that the hydrogel dressings were able to reduce the viable bacteria count by more than 6 log orders for MRSA and more than 4 log orders for PA01. This equated to an effective killing of more than 99.9999% of MRSA and more than 99.99% of PA01. The hydrogels performed impressively and significantly eradicated most of the bacteria in the infection model, and PEI hydrogel even reduced the inflammation levels in infected mice skin. In vivo time killing experiments were also done to quantify the speed at which the hydrogels kill the bacteria. It was determined that the hydrogels were able to kill more than 99.99% of the bacteria in as fast as 1 h.

The bacterial killing of biofilm bacteria was compared with commercial wound dressings as an indication of the efficacy of the hydrogel dressing in a clinical setting. Mice wounds were infected with MRSA and PA01 for 24 h to simulate a biofilm infection before treating with the respective dressings for a further 24 h. Commercial antimicrobial wound dressings used were Allevyn Ag and Algisite Ag, both from Smith & Nephew, which contain silver as an antimicrobial agent in their dressings. The bacteria count of the control wounds increased by about one order at the end of the experiment. Both Allevyn Ag and Algisite Ag reduced the bacteria count by one log order for MRSA and one to two log orders for PA01, whereas PEI hydrogel treated wounds had a bacterial reduction of 4 log orders for both MRSA and PA01 (FIG. 10). It is proven that the PEI hydrogel has a better in vivo bacteria biofilm killing than the two commercial antimicrobial wound dressings tested.

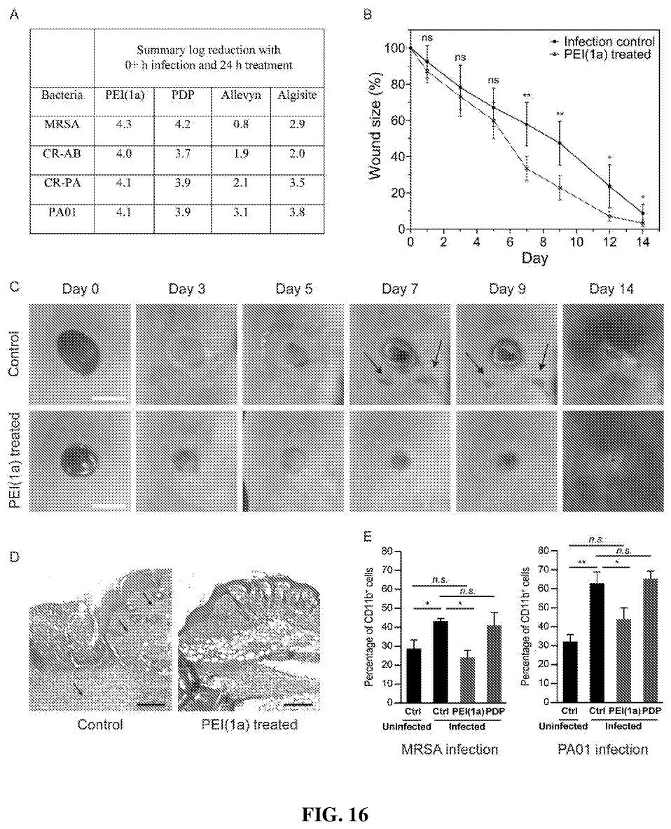

A two week long wound healing study was done on mice to investigate the effect of the hydrogel on the healing rate of skin wounds. PEI hydrogel was chosen for this study because of its excellent in vivo antimicrobial efficacy as well as non-inflammatory and compared with untreated control (Tegaderm), and MRSA USA300 was used in this experiment. At all day points, the healing rate of the PEI hydrogel treated wounds were faster than the control wounds, as the wound size in percentage of the initial size was smaller (FIG. 16). Moreover, the PEI hydrogel treated wounds were cleaner than the control wounds, as much more pus can be observed on the control wounds. Furthermore, secondary wound sites can be seen on the control wounds and are most likely caused by the spread of infection to nearby skin areas. A comparison (not shown) between six different control and PEI hydrogel treated wounds on day 7 showed that 5 out of 6 control wounds have secondary wound sites while none of the PEI hydrogel treated wounds have secondary wound sites. When treated with PEI hydrogel, MRSA was completely wiped out after three days, while the bacteria on the control wounds were slowly killed by the mice's immune system, and a significant amount still remains after 14 days.

The antimicrobial action of immobilized cationic polymers may be due to their ability to interact strongly with negatively charged phospholipids, allowing electrostatic interactions to govern initial binding to target cell membranes, and then the hydrophobic moieties on polymers interact with the inner hydrophobic core of the bacterial membrane resulting in a disruption in integrity and subsequent cell death. Thus, surface charge density and hydrophobicity are the main factors that affect antimicrobial activity of surface coatings. Since the pKa value of the imino group is approximately 10 to 11, PEI is a positively charged molecule in the physiological environment solutions (pH about 7.2).

To further improve its antimicrobial properties, hydrophobicity groups such as alkyl moieties are introduced into polymer backbone. The antimicrobial activities of PEI hydrogels using alkylated and non-alkylated PEI were investigated, as well as PEI with different molecular weights. The non-alkylated PEI hydrogel performed equally well as the alkylated version, and does not induce inflammation in the skin unlike the alkylated version. Also, it has superior properties like higher mechanical strength, bigger pore size, higher swelling and more biocompatible with mammalian cells due to its hydrophilicity, as compared to its hydrophobic counterpart. When compared with commercial antimicrobial wound dressings (Allevyn Ag and Algisite Ag) in an in vivo wound infection model, it outperforms them by killing 4 log orders of bacteria tested (MRSA and PA01) as compared to one to two log orders for the commercial ones. Treatment with PEI hydrogel also left a clean wound without much pus unlike the control wounds that was filled with pus and even had secondary wound sites near the infected wound. Therefore, present hydrogel technology is promising in the biomedical field as a potential treatment to infection-related wounds.

Conclusion

Polyethylenimine (PEI) was chosen as a backbone in order to develop an antimicrobial hydrogel, due to its highly branched nature and containing many cationic amine groups. The PEI was modified by grafting PEGMA groups and was able to crosslink to form a hydrogel. Further alkylation of the PEI with hydrophobic decane groups was carried out to improve its antimicrobial properties. However, for the in vitro antimicrobial test, the PEI hydrogel was able to perform as good as the PDP hydrogel, killing all bacteria that was inoculated on the surface. The transwell and contact MTT of both hydrogels were also very similar, suggesting that the hydrogels are very biocompatible and suitable to be used in a wound dressing. The mice model proved that the hydrogels were able to eradicate most bacteria on the wound surface, and even helps in wound healing. The antimicrobial hydrogels presented herein were proven to be very effective for use as an antimicrobial for infected wounds. This technology is an advantage to many commercial products as it avoids using silver commonly found in many antimicrobial wound dressings, which might be toxic and carcinogenic to the body. There are many other advantages of present hydrogel technology to be used in the clinical setting. As discussed, the hydrogel only requires a 2-step synthesis and a rapid UV polymerization process. The hydrogel has high and fast swelling which is good in managing wound exudates, and are transparent hence able to see the wound condition without removing the dressing. Also, the hydrogel is stable and does not break or degrade upon treatment, and leaves a clean wound when treatment is complete. This hydrogel can also potentially be explored in other biomedical applications, e.g. forming hydrogel coatings to combat many implant related infections.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. An antimicrobial polymer or hydrogel comprising a branched polyethylenimine (PEI) grafted with poly(ethylene glycol) methacrylate (PEGMA) of formula (I) or a branched polyethylenimine (PEI) grafted with poly(ethylene glycol) methacrylate (PEGMA) and decane of formula (II), 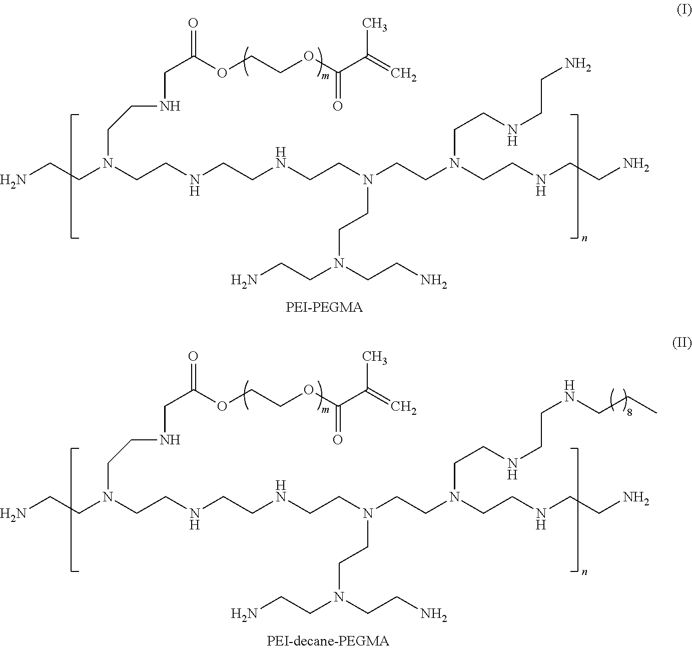
wherein:
m is an integer ranging from 1 to 20;
n is an integer ranging from 1 to 20;
in formula (I), the grafting ratio of PEI-PEGMA ranges from 1:1 to 1:20; and
in formula (II), the grafting ratio of PEI-decane-PEGMA ranges from 1:1:1 to 1:20:20.

2. The antimicrobial polymer or hydrogel of claim 1, wherein in formula (I), the grafting ratio of PEI-PEGMA is 1:5, 1:10, or 1:20.

3. The antimicrobial polymer or hydrogel of claim 1, wherein in formula (II), the grafting ratio of PEI-decane is 1:10.

4. The antimicrobial polymer or hydrogel of claim 3, wherein in formula (II), the grafting ratio of PEI-decane-PEGMA is 1:10:1, 1:10:2, 1:10:4, 1:10:8, or 1:10:16.

5. The antimicrobial polymer or hydrogel of claim 1, wherein PEI has an average molecular weight of between 800 and 750 K Da.

6. The antimicrobial polymer or hydrogel of claim 5, wherein PEI has an average molecular weight of 800, 25 K, or 750 K Da.

7. A method for forming an antimicrobial polymer of formula (I) of claim 1, the method comprising:
dissolving polyethylenimine (PEI) in deionized water to form a PEI solution;
adding an alkali solution to the PEI solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (I).

8. A method for forming an antimicrobial polymer of formula (II) of claim 1, the method comprising:
dissolving a decane-grafted polyethylenimine (PEI-decane) in deionized water to form a PEI-decane solution;
adding an alkali solution to the PEI-decane solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (II).

9. A method for forming an antimicrobial hydrogel of formula (I) or formula (II) of claim 1, the method comprising:
dissolving an antimicrobial polymer of formula (I) or formula (II), a crosslinker, and a UV initiator in deionized water to form a hydrogel solution; and
irradiating the hydrogel solution with UV light to form the antimicrobial hydrogel.

10. A method for forming on a surface a coating of an antimicrobial hydrogel of formula (I) or formula (II) of claim 1, the method comprising:
dissolving an antimicrobial polymer of formula (I) or formula (II), a crosslinker, and optionally, a UV initiator, in deionized water to form a hydrogel solution;
subjecting the surface to a modification treatment;
depositing the hydrogel solution onto the modified surface; and
irradiating the hydrogel solution with UV light to form the coating of the antimicrobial hydrogel.

11. The method of claim 10, wherein the modification treatment comprises a plasma treatment, an ozone treatment, an iron (II) oxide treatment, or any other treatments that generate free radicals on the surfaces.

12. A device having a surface coated with an antimicrobial hydrogel of formula (I) or formula (II) of claim 1.

13. A method for killing microorganisms, the method comprising contacting an antimicrobial polymer or hydrogel of formula (I) or formula (II) of claim 1 with the microorganisms.

14. An antimicrobial polymer or hydrogel comprising a branched polyethylenimine (PEI) grafted with poly(ethylene glycol) methacrylate (PEGMA) and alkyl (R) of formula (III), 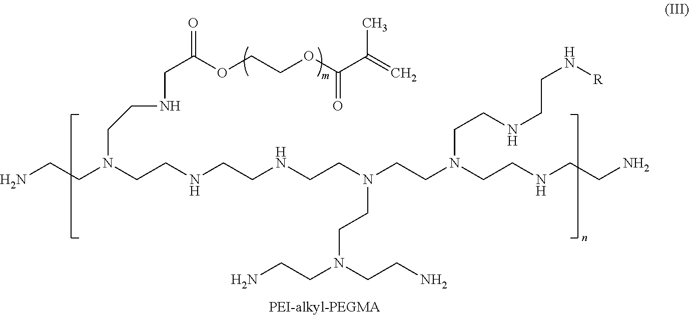
wherein:
m is an integer ranging from 1 to 20;
n is an integer ranging from 1 to 20;
R is a linear or branched, substituted or unsubstituted C5-C15 alkyl; and
the grafting ratio of PEI-alkyl-PEGMA ranges from 1:1:1 to 1:20:20.

15. A method for forming an antimicrobial polymer of formula (III) of claim 14, the method comprising:
dissolving an alkyl-grafted polyethylenimine (PEI-alkyl) in deionized water to form a PEI-alkyl solution;
adding an alkali solution to the PEI-alkyl solution to form a solution mixture;
adding dropwise a chloro-functionalized polyethylene glycol methacrylate solution to the solution mixture to form a final mixture;
stirring the final mixture before dialyzing the final mixture; and
lyophilizing the final mixture to obtain the antimicrobial polymer of formula (III).

16. A method for forming an antimicrobial hydrogel of formula (III) of claim 14, the method comprising:
dissolving an antimicrobial polymer of formula (III), a crosslinker, and a UV initiator in deionized water to form a hydrogel solution; and
irradiating the hydrogel solution with UV light to form the antimicrobial hydrogel. irradiating the hydrogel solution with UV light to form the antimicrobial hydrogel.

17. A method for forming on a surface a coating of an antimicrobial hydrogel of formula (III) of claim 14, the method comprising:
dissolving an antimicrobial polymer of formula (III), a crosslinker, and optionally, a UV initiator, in deionized water to form a hydrogel solution;
subjecting the surface to a modification treatment;
depositing the hydrogel solution onto the modified surface; and
irradiating the hydrogel solution with UV light to form the coating of the antimicrobial hydrogel.

18. The method of claim 17, wherein the modification treatment comprises a plasma treatment, an ozone treatment, an iron (II) oxide treatment, or any other treatments that generate free radicals on the surfaces.

19. A device having a surface coated with an antimicrobial hydrogel of formula (III) of claim 14.

20. A method for killing microorganisms, the method comprising contacting an antimicrobial polymer or hydrogel of formula (III) of claim 14 with the microorganisms.
